(19) United States
(12) Patent Application Publication
(10) Pub. No.: US 2013/0277521 A1
(43) Pub. Date: Oct. 24, 2013

(54) CONNECTION DEVICE

(71) Applicant: SONY CORPORATION, Tokyo (JP)

(72) Inventors: Yukio Hiramoto, Kanagawa (JP); Takayoshi Fukiya, Saitama (JP); Asaya Hondo, Chiba (JP)

(21) Appl. No.: 13/654,048

(22) Filed: Oct. 17, 2012

(30) Foreign Application Priority Data
Oct. 24, 2011 (JP) 2011-232775

(51) Int. Cl. F16M 13/00

(52) U.S. Cl. CPC F16M 13/00
USPC 248/274.1

(57) ABSTRACT

Disclosed herein is a connection device including: a holder adapted to hold an electronic device; an adjuster that is supported by the holder in a manner free to move in a predetermined direction and that comes into contact with the electronic device held by the holder; and a biasing spring adapted to bias the adjuster in the direction in which the adjuster is pressed against the electronic device held by the holder, wherein at least part of the adjuster is provided as an elastic deformation section that can be elastically deformed when pressed by the electronic device, and when the electronic device is held by the holder, the adjuster is moved according to the size of the electronic device so as to cause the biasing spring or the biasing spring and elastic deformation section to elastically deform.

### CROSS-REFERENCE TO RELATED APPLICATION

The present application claims priority from Japanese Patent Application No. JP 2011-232775 filed in the Japanese Patent Office on Oct. 24, 2011, the entire content of which is incorporated herein by reference.

### BACKGROUND

The present technology relates to a technical field of a connection device. More particularly, the present technology relates to a technical field of a connection device that allows electronic devices of different sizes to be readily attached to a holder while at the same time ensuring downsizing of the connection device by elastically deforming a biasing spring or an elastic deformation section of an adjuster according to the size of the electronic device held by the holder.

Connection devices are available to which an electronic device such as a portable digital music player or mobile phone is connected.

Each of these connection devices has, for example, a holder adapted to hold the electronic device and is attached, for example, to the dashboard in a car. The connection device is connected, for example, to a processor (digital signal processor unit) adapted to output data or other information to a vehicle-mounted speaker unit. When the connection device is connected to the processor, music data and other information of the electronic device held by the holder is transmitted to the speaker unit via the processor, thus allowing a high-quality sound to be output from the speaker unit.

Some of the above connection devices permit attachment of electronic devices of different sizes (thicknesses) (refer, for example, to Japanese Utility Model Laid-open No. Hei 10-139 (Patent Document 1) and Japanese Patent Laid-open No. 2001-77899 (Patent Document 2)).

In the connection device described in Patent Document 1, front and rear surface plates are coupled by a link mechanism, and the distance between the front and rear surface plates changes according to the movement of the link mechanism so that electronic devices of different thicknesses are held between the front and rear surface plates.

In the connection device described in Patent Document 2, an attachable/detachable protruding member is provided on the rear surface plate, and if the protruding member is attached to the rear surface plate in a different orientation, the position of the front surface of the protruding member relative to the rear side plate changes, thus allowing electronic devices of different thicknesses to be held.

### SUMMARY

In the connection device described in Patent Document 1, however, the mechanism adapted to handle the thickness of an electronic device is complicated because the mechanism includes the front and rear surface plates and the link mechanism adapted to couple the plates. Besides, there are a large number of components, thus making it difficult to downsize the connection device.

In the connection device described in Patent Document 2, on the other hand, it is necessary to attach the protruding member to the rear surface plate in a different orientation according to the thickness of each of electronic devices of different thicknesses. This makes the attachment of an electronic device troublesome, thus making it difficult to attach an electronic device with ease.

In light of the foregoing, it is desirable to overcome the above problems and allow electronic devices of different sizes to be readily attached to the holder while at the same time ensuring downsizing of the connection device.

Firstly, according to an embodiment of the present technology, there is provided a connection device that includes a holder, adjuster and biasing spring. The holder holds an electronic device. The adjuster is supported by the holder in a manner free to move in a predetermined direction and comes into contact with the electronic device held by the holder. The biasing spring biases the adjuster in the direction in which the adjuster is pressed against the electronic device held by the holder. At least part of the adjuster is provided as an elastic deformation section that can be elastically deformed when pressed by the electronic device. When the electronic device is held by the holder, the adjuster is moved according to the size of the electronic device, thus causing the biasing spring or the biasing spring and elastic deformation section to elastically deform.

In the connection device, therefore, when an electronic device is held by the holder, the biasing spring or the biasing spring and elastic deformation section are pressed by the electronic device, thus causing the biasing spring or the biasing spring and elastic deformation section to elastically deform.

Secondly, in the connection device, it is preferred that the predetermined direction should be a direction along the thickness of the electronic device.

If the predetermined direction is the direction along the thickness of the electronic device, the biasing spring or the biasing spring and elastic deformation section are pressed by the electronic device when the electronic device is held by the holder, thus causing the biasing spring or the biasing spring and elastic deformation section to be elastically deformed in the direction along the thickness of the electronic device.

Thirdly, in the connection device, it is preferred that a flange section projecting outward from the elastic deformation section should be provided on the adjuster, and that the flange section should be formed with a resin or metallic material.

If the flange section projecting outward from the elastic deformation section is provided on the adjuster, and if the flange section is formed of a resin or metallic material, the adjuster offers higher rigidity, thus preventing the adjuster from being plastically deformed when pressed by the electronic device.

Fourthly, in the connection device, it is preferred that the elastic deformation section and other sections of the adjuster should be integrally formed.

If the elastic deformation section and other sections of the adjuster are integrally formed, the adjuster is formed with a single component.

Fifthly, in the connection device, it is preferred that the elastic deformation section should be formed with a rubber material.

If formed with a rubber material, the elastic deformation section is easier to deform when the adjuster is pressed by the electronic device.

Sixthly, in the connection device, it is preferred that a guide section should be provided to guide the adjuster in the predetermined direction.

If the guide section is provided to guide the adjuster in the predetermined direction, the adjuster is not tilted in the direction in which it is moved.

Seventhly, in the connection device, it is preferred that the guide section should be provided integrally with the holder.

If the guide section is provided integrally with the holder, the number of components is reduced.

Eighthly, in the connection device, it is preferred that a movement restriction section should be provided to restrict the movement of the adjuster in the predetermined direction by a given distance or more when the electronic device is held by the holder, and that the elastic deformation section should be elastically deformed when the movement of the adjuster is restricted by the movement restriction section.

If the movement restriction section is provided to restrict the movement of the adjuster in the predetermined direction by a given distance or more when the electronic device is held by the holder, and if the elastic deformation section can be elastically deformed with the movement of the adjuster restricted by the movement restriction section, the adjuster is moved a shorter distance.

Ninthly, in the connection device, it is preferred that the movement restriction section should be provided integrally with the holder.

If the movement restriction section is provided integrally with the holder, the number of components is reduced.

Tenthly, in the connection device, it is preferred that the adjuster should have a contact section adapted to come into contact with the electronic device and an outer peripheral section adapted to protrude from an outer peripheral edge of the contact section, that an insertion/arrangement hole should be formed to allow part of the adjuster to be inserted and arranged in the holder, and that the outer peripheral section should be formed in such a manner as to be larger in outer diameter with increase in distance from the contact section.

If the insertion/arrangement hole is formed to allow part of the adjuster to be inserted and arranged in the holder, and if the outer peripheral section is formed in such a manner as to be larger in outer diameter with increase in distance from the contact section, the elastic deformation section does not squeeze out of the insertion/arrangement hole when elastically deformed.

Eleventhly, in the connection device, it is preferred that a base section and a pair of holding protruding sections should be provided in the holder. The base section supports the adjuster. Each of the holding protruding sections protrudes approximately in the same direction from one of two end portions of the base section and engages with one of two end portions of the electronic device to sandwich the electronic device.

If the base section adapted to support the adjuster and the pair of holding protruding sections, each of which protrudes approximately in the same direction from one of two end portions of the base section and engages with one of two end portions of the electronic device to sandwich the electronic device, are provided in the holder, the electronic device is sandwiched between the pair of holding protruding sections, thus allowing it to be held by the holder.

The connection device according to the embodiment of the present technology includes a holder, adjuster and biasing spring. The holder holds an electronic device. The adjuster is supported by the holder in a manner free to move in a predetermined direction and comes into contact with the electronic device held by the holder. The biasing spring biases the adjuster in the direction in which the adjuster is pressed against the electronic device held by the holder. At least part of the adjuster is provided as an elastic deformation section that can be elastically deformed when pressed by the electronic device. When the electronic device is held by the holder, the adjuster is moved according to the size of the electronic device, thus causing the biasing spring or the biasing spring and elastic deformation section to elastically deform.

Therefore, the elastic deformation section is elastically deformed when a large electronic device is held by the holder. As a result, the adjuster does not move a given distance or more. This provides a sufficient space for the structure of other sections of the connection device, thus allowing electronic devices of different sizes to be held while at the same time ensuring downsizing of the connection device.

Further, the attachment and detachment of electronic devices of different sizes to and from the connection device can be always accomplished in the same manner, thus permitting easy attachment or detachment of the electronic device to or from the holder.

In an embodiment of the present technology, the predetermined direction is a direction along the thickness of the electronic device.

Therefore, it is possible to hold electronic devices of different thicknesses while at the same time ensuring downsizing of the connection device in the direction along the thicknesses of the electronic devices.

In another embodiment of the present technology, a flange section projecting outward from the elastic deformation section is provided on the adjuster, and the flange section is formed with a resin or metallic material.

Therefore, the adjuster offers higher rigidity, thus preventing the adjuster from being plastically deformed when pressed by the electronic device, and ensuring excellent functionality of the adjuster.

In still another embodiment of the present technology, the elastic deformation section and other sections of the adjuster are integrally formed.

Therefore, it is possible to readily form the adjuster and reduce the number of components, thus contributing to reduced manufacturing cost of the connection device.

In still another embodiment of the present technology, the elastic deformation section is formed with a rubber material.

Therefore, the elastic deformation section can be elastically deformed in a positive manner when the adjuster is pressed by the electronic device.

In still another embodiment of the present technology, a guide section is provided to guide the adjuster in the predetermined direction.

Therefore, the adjuster is not tilted in the direction in which it is moved, thus ensuring smooth movement of the adjuster.

In still another embodiment of the present technology, the guide section is provided integrally with the holder.

Therefore, the number of components can be reduced.

In still another embodiment of the present technology, a movement restriction section is provided to restrict the movement of the adjuster in the predetermined direction by a given distance or more when the electronic device is held by the holder, and the elastic deformation section can be elastically deformed when the movement of the adjuster is restricted by the movement restriction section.

Therefore, the adjuster need only move a shorter distance, thus ensuring downsizing of the adjuster.

In still another embodiment of the present technology, the movement restriction section is provided integrally with the holder.

Therefore, the number of components can be further reduced.

In still another embodiment of the present technology, the adjuster has a contact section adapted to come into contact with the electronic device and an outer peripheral section adapted to protrude from an outer peripheral edge of the contact section, and an insertion/arrangement hole is formed to allow part of the adjuster to be inserted and arranged in the holder, and the outer peripheral section is formed in such a manner as to be larger in outer diameter with increase in distance from the contact section.

Therefore, the elastic deformation section does not squeeze out of the insertion/arrangement hole with the elastic deformation section elastically deformed, thus ensuring proper holding of the electronic device by the holder and preventing scratches and damage to the adjuster.

In still another embodiment of the present technology, a base section and a pair of holding protruding sections are provided in the holder. The base section supports the adjuster. Each of the holding protruding sections protrudes approximately in the same direction from one of two end portions of the base section and engages with one of two end portions of the electronic device to sandwich the electronic device.

Therefore, the holder can positively and readily hold the electronic device.

### BRIEF DESCRIPTION OF THE DRAWINGS

FIG. 1 illustrates, together with FIGS. 2 to 32, a connection device according to an embodiment of the present technology, and is perspective views illustrating the connection device and electronic devices of different thicknesses connected to the connection device;

FIG. 2 is perspective views illustrating the electronic devices with protective covers;

FIG. 3 is perspective views illustrating the connection device with a stand detached from a holder;

FIG. 4 is an exploded perspective view illustrating part of the connection device;

FIG. 5 is an enlarged front view illustrating inner structural sections of an upper enclosure;

FIG. 6 is an enlarged back view illustrating the upper portion of a front panel of a lower enclosure;

FIG. 7 is a side view of the connection device;

FIG. 8 is a front view of the connection device;

FIG. 9 illustrates, together with FIGS. 10 to 12, an adjuster, and is an enlarged front view;

FIG. 10 is an enlarged side view;

FIG. 11 is a cross-sectional view taken along line XI-XI in FIG. 9;

FIG. 12 is a cross-sectional view taken along line XII-XII in FIG. 9;

FIG. 13 is a cross-sectional view taken along line A-A in FIG. 8;

FIG. 14 is a cross-sectional view taken along line B-B in FIG. 8;

FIG. 15 is a side view of the connection device as seen from the direction opposite to that in FIG. 7;

FIG. 16 is a block diagram illustrating the connections of the connection device to other sections;

FIG. 17 illustrates, together with FIGS. 18 to 32, the attachment and detachment of the electronic device to and from the connection device, and is an enlarged cross-sectional view illustrating the connection device before the connection of the electronic device;

FIG. 18 is an enlarged cross-sectional view different from FIG. 17 and illustrates the connection device before the connection of the electronic device;

FIG. 19 is a side view illustrating the connection device immediately after the start of the attachment of a thin electronic device;

FIG. 20 is a side view illustrating the connection of a female connector of the thin electronic device to a male connector;

FIG. 21 is a side view illustrating that the thin electronic device is parallel to a base section after being pressed rearward;

FIG. 22 is an enlarged cross-sectional view illustrating that the adjuster is pressed by the thin electronic device and moved;

FIG. 23 is an enlarged cross-sectional view different from FIG. 22 and illustrates that the adjuster is pressed by the thin electronic device and moved;

FIG. 24 is a side view illustrating that the thin electronic device is held by the holder and connected to the connection device;

FIG. 25 is a side view illustrating that the thin electronic device is tilted forward during removal from the connection device;

FIG. 26 is a side view illustrating that the adjuster is pressed by a thick electronic device and moved, with the female connector of the electronic device connected to the male connector;

FIG. 27 is an enlarged cross-sectional view illustrating the restriction of rearward movement of the adjuster;

FIG. 28 is a side view illustrating that the thick electronic device is held by the holder and connected to the connection device;

FIG. 29 is an enlarged cross-sectional view illustrating that an elastic deformation section is elastically deformed when the adjuster is pressed rearward by the thick electronic device;

FIG. 30 is an enlarged cross-sectional view different from FIG. 29 and illustrates that the elastic deformation section is elastically deformed when the adjuster is pressed rearward by the thick electronic device;

FIG. 31 is a side view illustrating that the thick electronic device with the protective cover is held by the holder and connected to the connection device; and

FIG. 32 is an enlarged cross-sectional view illustrating that the elastic deformation section is elastically deformed when the adjuster is pressed rearward by the thick electronic device with the protective cover.

### DETAILED DESCRIPTION OF THE PREFERRED EMBODIMENTS

A description will be given below of the best mode for carrying out the connection device according to an embodiment of the present technology with reference to the accompanying drawings.

In the best mode to be described below, the connection device according to the embodiment of the present technology is applied to a connection device connected to a processor adapted, for example, to output data and other information to a vehicle-mounted speaker unit used inside a car.

It should be noted, however, that the present technology is not limited in application to a connection device connected to a processor adapted, for example, to output data and other information to a vehicle-mounted speaker unit used inside a car. The connection device according to the embodiment of the present technology is broadly applicable to a variety of connection devices adapted to hold an electronic device. In particular, the connection device is suitable for use as a connection device referred to as a so-called cradle to which a mobile phone or portable digital music player (DMP) is connected.

### [Schematic Configuration of Electronic Devices]

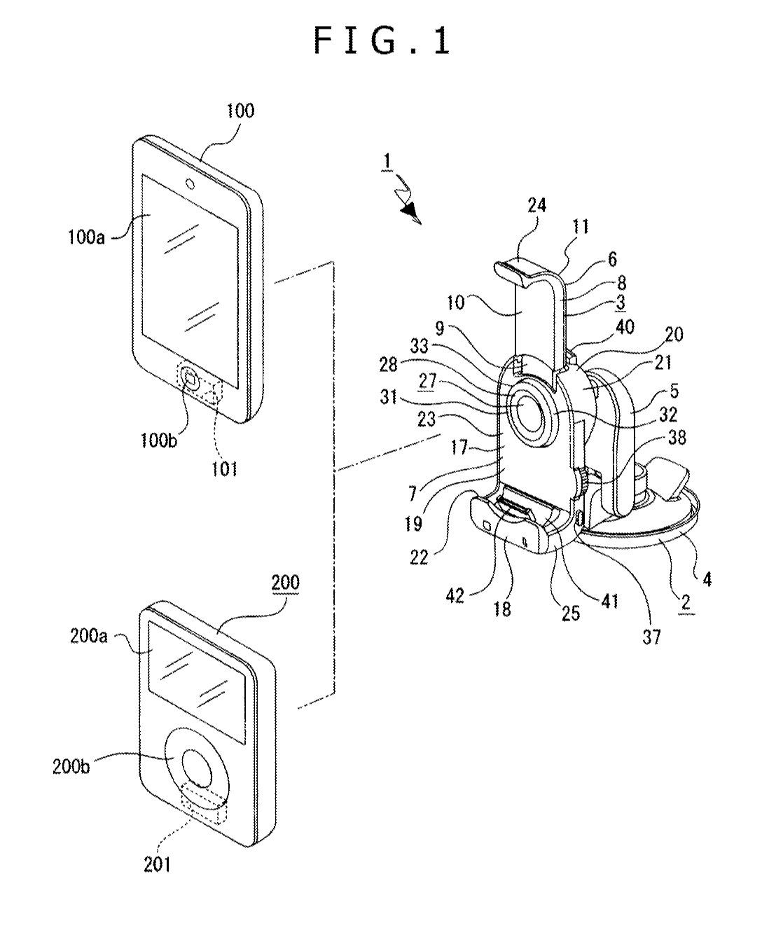

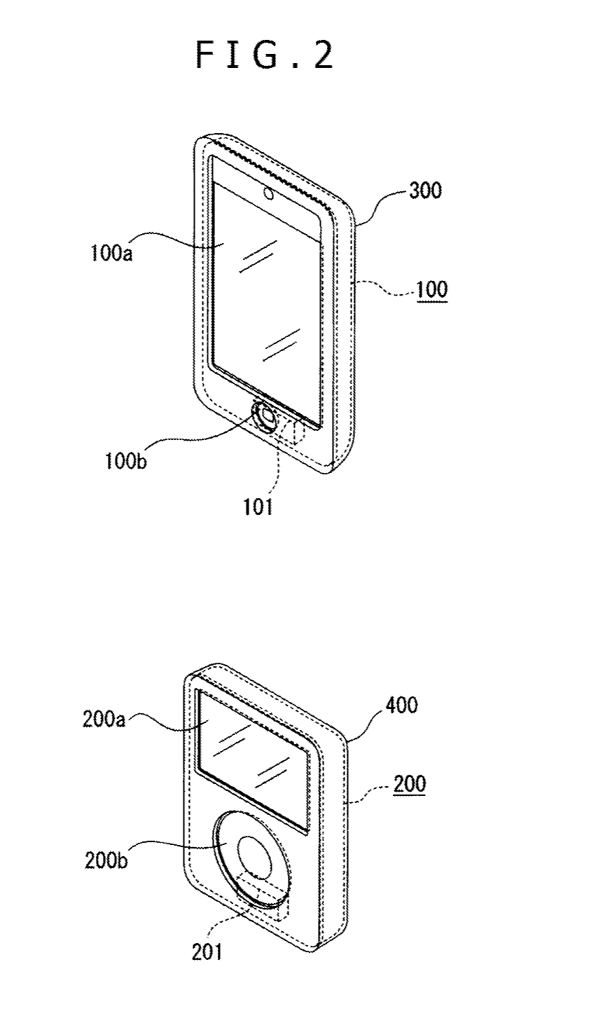

A description will be given first of electronic devices connected to the connection device (refer to FIGS. 1 and 2).

Electronic devices 100 and 200 of different thicknesses are selectively connectable to the connection device (refer to FIG. 1).

The electronic device 100 is, for example, a portable DMP and formed in a flat-faced and vertically long shape or approximately rectangular shape. The direction along the thickness of the electronic device 100 is the longitudinal direction.

The electronic device 100 has a display surface 100a and operation section 100b on the front face thereof. The display surface 100a also serves, for example, as a touch panel and allows predetermined processes to be performed such as externally outputting recorded music data or other information and selecting music data by manipulating the display surface 100a or operation section 100b.

A female connector 101 is provided on the lower end portion of the electronic device 100. The female connector 101 is open downward.

The electronic device 200 is, for example, a portable DMP and formed in a flat-faced and vertically long shape or approximately rectangular shape. The direction along the thickness of the electronic device 200 is the longitudinal direction. The electronic device 200 is, for example, thicker than the electronic device 100.

The electronic device 200 has a display surface 200a and operation section 200b on the front face thereof. The display surface 200a also serves, for example, as a touch panel and allows predetermined processes to be performed such as externally outputting recorded music data or other information and selecting music data by manipulating the display surface 200a or operation section 200b.

A female connector 201 is provided on the lower end portion of the electronic device 200. The female connector 201 is open downward.

Protective covers 300 and 400 are attachable to and detachable from the electronic devices 100 and 200, respectively (refer to FIG. 2). The protective covers 300 and 400 are each formed with a flexible material such as silicon rubber, and attached respectively to the electronic devices 100 and 200 to prevent scratches and damage. The protective covers 300 and 400 are each, for example, about 1 mm in thickness.

With the protective covers 300 and 400 attached respectively to the electronic devices 100 and 200, the electronic devices 100 and 200 and the protective covers 300 and 400 combined are respectively larger than the electronic devices 100 and 200 by the sizes of the protective covers 300 and 400.

### [Configuration of the Connection Device]

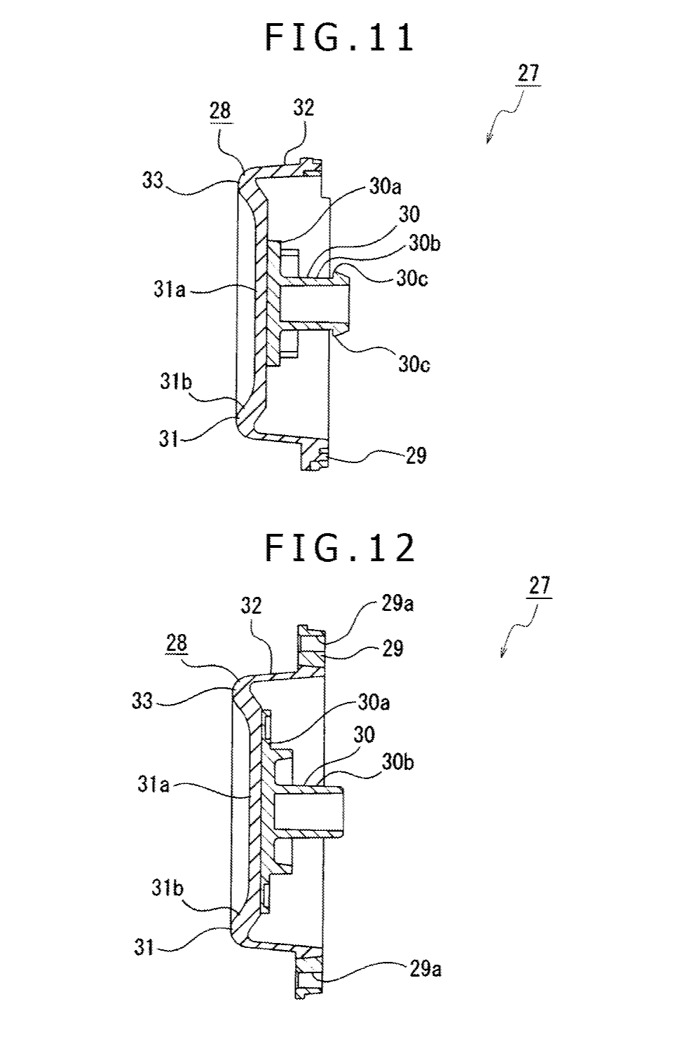

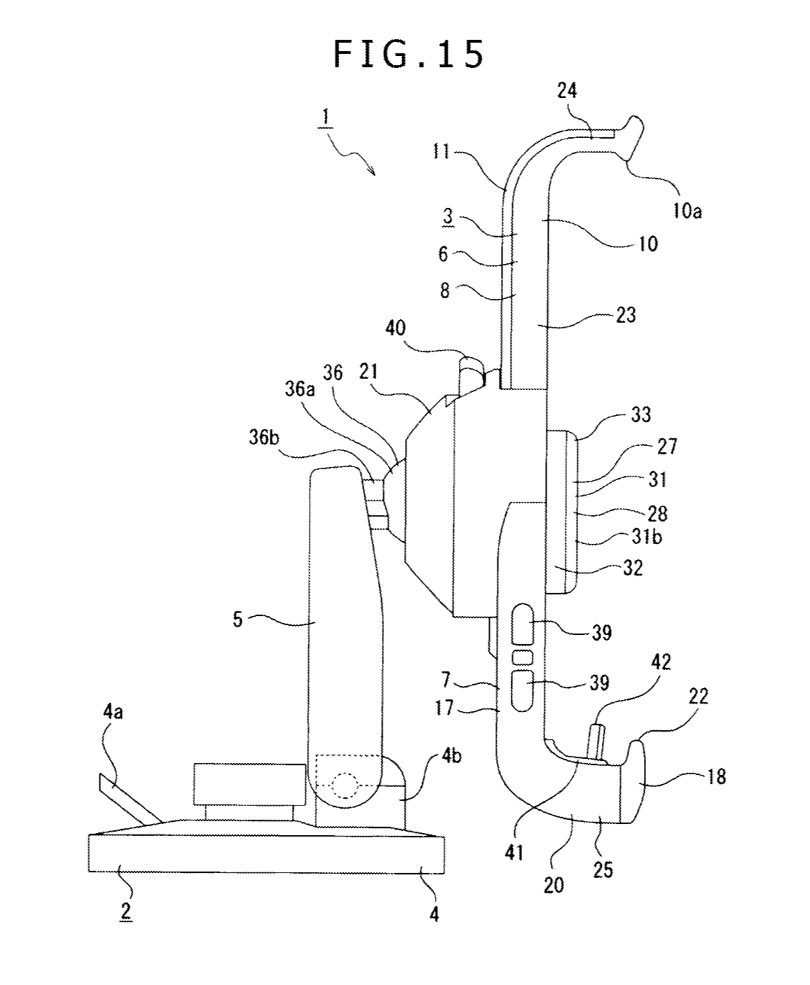

A description will be given next of the connection device (refer to FIG. 1 and FIGS. 3 to 15).

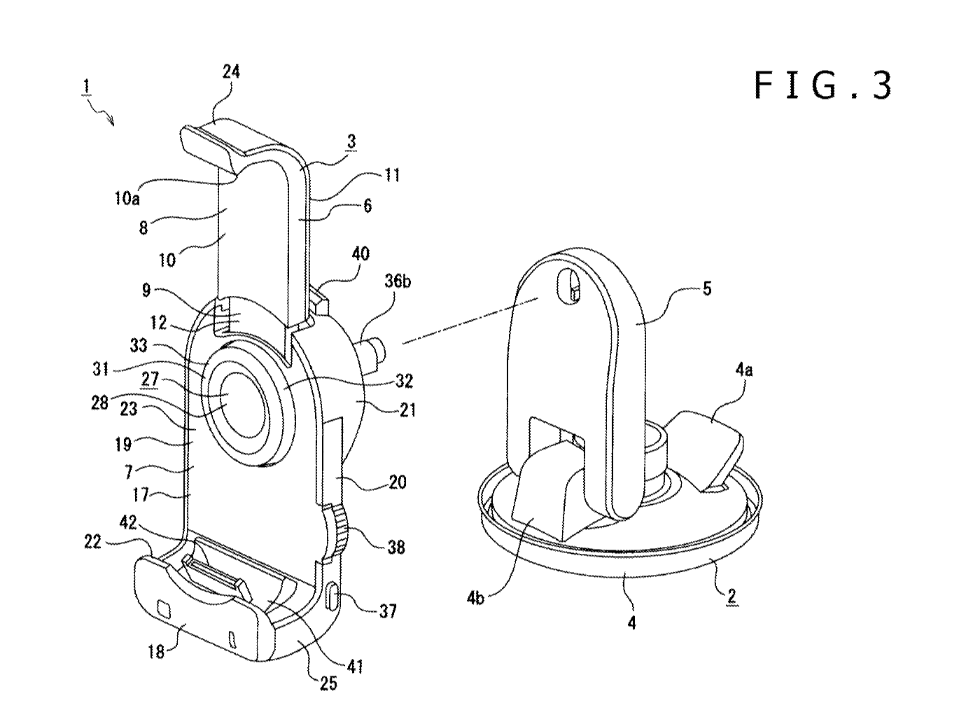

A connection device 1 has a stand 2 and holder 3 (refer to FIGS. 1 and 3).

The stand 2 has an attached plate 4 and supporting leg 5 connected to the attached plate 4 in a manner free to rotate. The attached plate 4 is formed approximately in a disc shape and oriented vertically and has a sucker not shown on the bottom. A suction operation portion 4a is provided on the attached plate 4. A supporting protruding portion 4b protruding upward is provided on the attached plate 4.

When the suction operation portion 4a is operated, the attached plate 4 is sucked or stops being sucked by the sucker onto the target surface such as the dashboard of a car.

The supporting leg 5 is coupled to the supporting protruding portion 4b of the attached plate 4 in a manner free to pivot. As the supporting leg 5 pivots, the upper end portion thereof is moved in the approximately longitudinal direction. Further, the supporting leg 5 can rotate with the rotation of part of the attached plate 4 in the circumferential direction.

The holder 3 has an upper enclosure 6 and lower enclosure 7 that are coupled vertically.

The upper enclosure 6 includes a frame section 8 and an inner structure section 9 located under the frame section 8 (refer to FIG. 3). The frame section 8 can move vertically relative to the inner structure section 9.

The frame section 8 includes a front cabinet 10 and rear panel 11 that are coupled longitudinally.

The front cabinet 10 is formed in a vertically long shape. The portions thereof other than the upper end portion are open rearward, and the portions of the upper end portion other than the front end portion are open upward and rearward. The upper end portion of the front cabinet 10 protrudes forward more than the other portions thereof. A position restriction protruding section 10a is provided on the front end portion of the front cabinet 10. The position restriction protruding section 10a protrudes downward.

The rear panel 11 is formed in a vertically long shape, and the upper end portion thereof protrudes forward more than the other portions thereof.

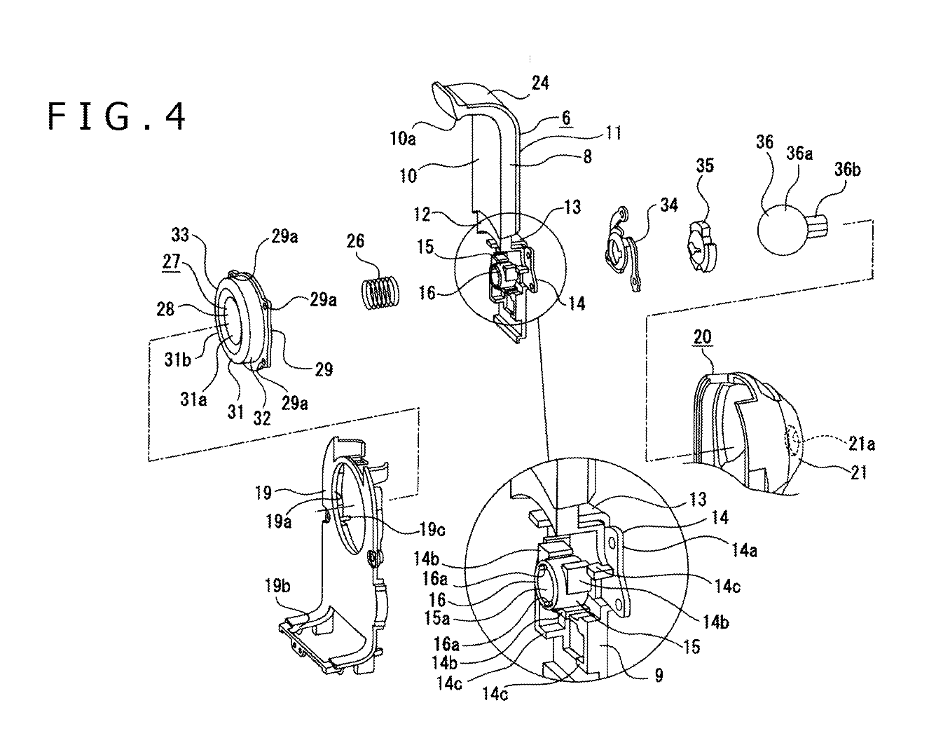

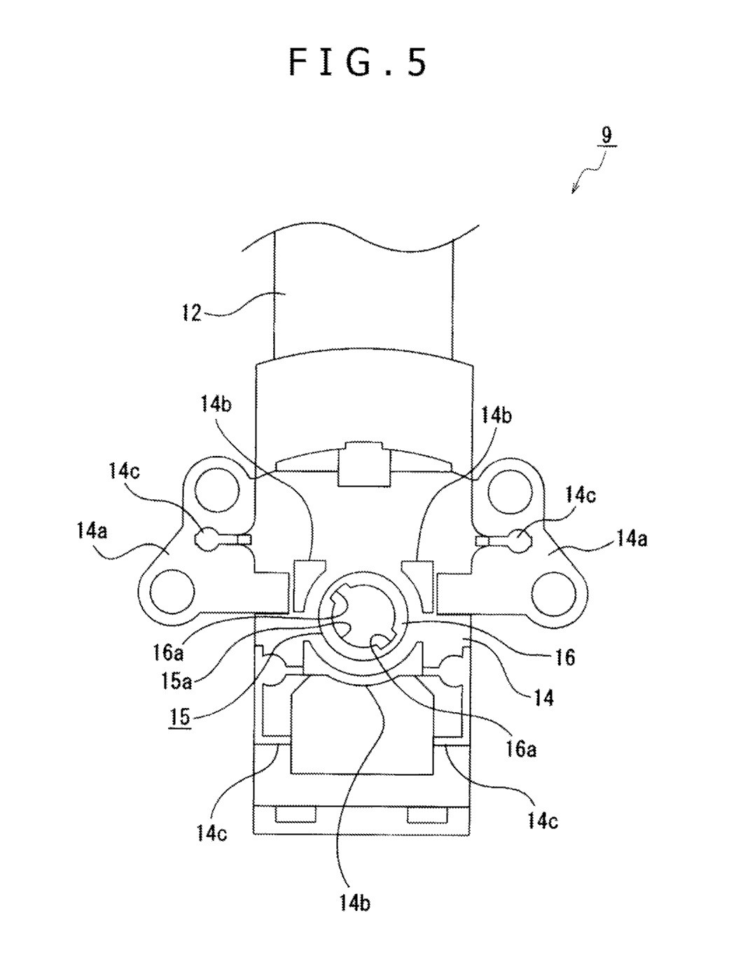

The inner structure section 9 includes a supporting portion 12, coupling portion 13, substrate portion 14 and supporting protruding portion 15 as illustrated in FIGS. 4 and 5. The supporting portion 12 is oriented in the approximately longitudinal direction. The coupling portion 13 protrudes rearward from the lower end portion of the supporting portion 12. The substrate portion 14 protrudes downward from the coupling portion 13 and is formed in the shape of a plate faced in the approximately longitudinal direction. The supporting protruding portion 15 protrudes forward approximately from the central portion of the substrate portion 14.

The frame section 8 is supported in a manner free to move vertically by the supporting portion 12.

The left and right side portions of the upper end portion of the substrate portion 14 are provided as attached parts 14a. The substrate portion 14 has spring holder protruding parts 14b that protrude forward and are provided around the supporting protruding portion 15.

Four movement restriction parts 14c are provided vertically and horizontally apart from each other on the substrate portion 14 and integrally with the holder 3. The movement restriction parts 14c protrude forward and are provided on the outer peripheral side of the spring holder protruding parts 14b. The front surfaces of the movement restriction parts 14c are located at the same position in the longitudinal direction.

The supporting protruding portion 15 is formed in an approximately cylindrical form extending longitudinally. The inner space thereof is formed as an insertion hole 15a, and an anti-slipout portion 16 projecting inward is provided on the front end portion of the supporting protruding portion 15. Inwardly open insertion cutouts 16a are formed at the positions of the anti-slipout portion 16 that are 180 degrees apart in the circumferential direction.

The lower enclosure 7 has a frame section 17 and a panel section 18 attached to the frame section 17 (refer to FIGS. 1 and 3).

The frame section 17 includes a front panel 19 and rear cabinet 20 that are coupled longitudinally.

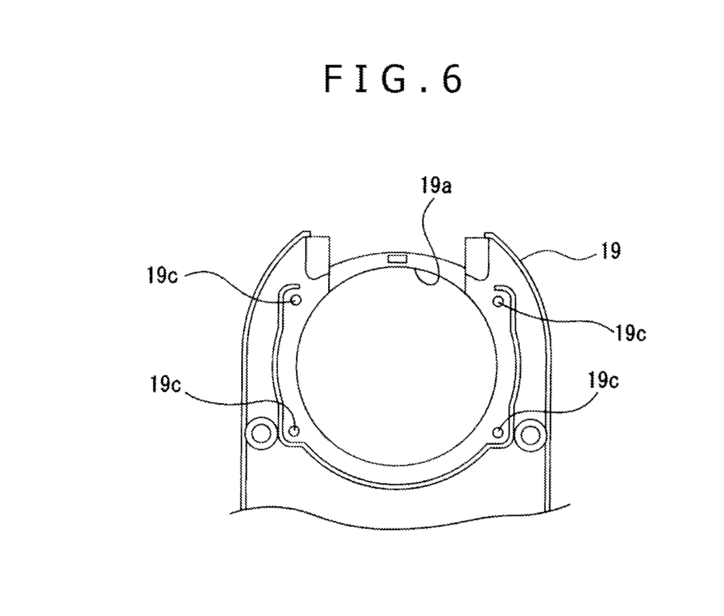

The front panel 19 is formed in a vertically long shape and has an insertion/arrangement hole 19a and arrangement hole 19b. The insertion/arrangement hole 19a longitudinally penetrates the front panel 19 at the upper end portion, and the arrangement hole 19b is in rectangular shape and vertically penetrates the front panel 19 at the lower end portion (refer to FIG. 4). The lower end portion of the front panel 19 protrudes forward more than the other portions thereof. Guide sections 19c are provided longitudinally and horizontally apart from each other on the rear surface of the front panel 19 and integrally with the holder 3. The guide sections 19c protrude rearward and are provided around the insertion/arrangement hole 19a (refer to FIGS. 4 and 6).

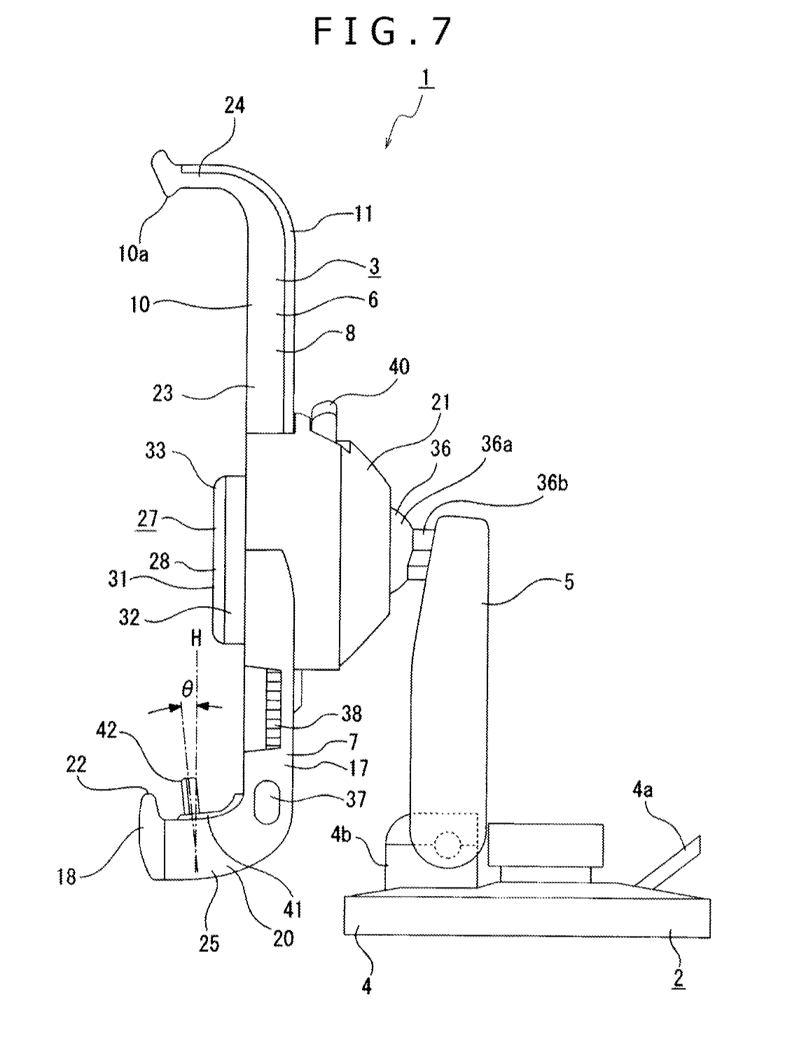

The rear cabinet 20 is formed in a vertically long shape, and the portions thereof other than the lower end portion are open forward, with the lower end portion being open upward and forward (refer to FIGS. 4 and 7). The lower end portion of the rear cabinet 20 protrudes forward more than the other portions thereof. A protruding arrangement section 21 protruding rearward is provided at the upper end portion of the rear cabinet 20, and an axial insertion hole 21a longitudinally penetrating the protruding arrangement section is formed at the rear end portion of the protruding arrangement section 21.

The panel section 18 is attached from the front to the lower end portion of the frame section 17 that includes the front panel 19 and rear cabinet 20 that are coupled together (refer to FIGS. 3, 7 and 8).

With the panel section 18 attached to the frame section 17, the upper end portion of the panel section 18 protrudes more upward than the top surface of the lower end portion of the frame section 17. This protruding portion is provided as a restriction protruding section 22.

The holder 3 includes the upper enclosure 6 and lower enclosure 7 that are coupled together, and the panel section 18 that is coupled to the lower enclosure 7. A base section 23 which includes the portions of the frame section 8 other than the upper end portion thereof and the portions of the frame section 17 other than the lower end portion thereof is provided on the holder 3. The base section 23 is oriented in the approximately longitudinal direction. The upper and lower end portions of the holder 3 are provided respectively as holding protruding sections 24 and 25 that protrude forward from the base section 23.

A biasing spring 26, i.e., a compressed coil spring expandable in the longitudinal direction, is arranged inside the upper end portion of the lower enclosure 7 (refer to FIG. 4). The biasing spring 26 is supported by the supporting protruding portion 15 provided in the inner structure section 9 of the upper enclosure 6 in such a manner that the rear end portion of the biasing spring 26 is fitted on the supporting protruding portion 15. The biasing spring 26 is pressed from therearound by the spring holder protruding parts 14b.

An adjuster 27 is supported by the upper end portion of the lower enclosure 7 in a manner free to move in the longitudinal direction. The adjuster 27 is formed by two-color molding using a rubber material such as elastomer and a resin material harder than this rubber material or a metallic material.

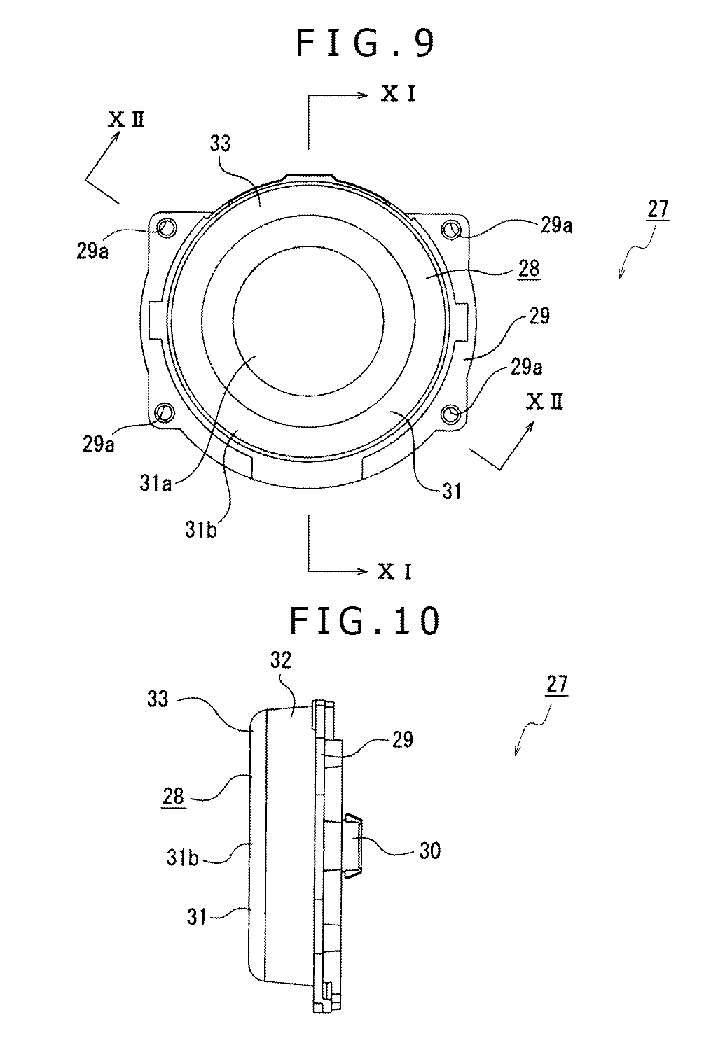

The adjuster 27 includes an adjustment section 28, flange section 29 and supported section 30 as illustrated in FIGS. 9 to 12. The adjustment section 28 has its outer shape formed in a circular shape. The flange section 29 projects outward from the rear end portion of the adjustment section 28. The supported section 30 is provided on the rear surface of the adjustment section 28.

The adjustment section 28 includes a contact portion 31 and outer peripheral portion 32, and is formed with a rubber material such as elastomer. The contact portion 31 is formed approximately in a disc shape. The outer peripheral portion 32 protrudes approximately rearward from the outer peripheral edge of the contact portion 31. The portions of the contact portion 31 other than that on the outer peripheral side are provided as a disc part 31a, and the portion on the outer peripheral side of the contact portion 31 is provided as a tilted part 31b tilted in such a manner that the more outward the tilted part 31b is from the disc part 31a, the more forward it is displaced.

The outer peripheral portion 32 is sloped gently in such a manner that the more rearward the outer peripheral portion 32 is, the somewhat more outward it is displaced.

The tilted part 31b of the contact portion 31 and the portions of the outer peripheral portion 32 other than the rear end portion are provided as an elastic deformation section 33 that is elastically deformable relative to the other portions.

The flange section 29 protrudes outward from the portions other than the upper end portion at the rear end portion of the outer peripheral portion 32. The flange section 29 is formed with a resin material higher in rigidity than the adjustment section 28 or a metallic material. Guided holes 29a longitudinally penetrating the flange section 29 are provided longitudinally and horizontally apart from each other.

The supported section 30 is formed with the same resin or metallic material as the flange section 29. The supported section 30 includes a base portion 30a, axial portion 30b and restricted protruding portions 30c. The base portion 30a is provided in a continuous manner on the rear surface of the disc part 31a of the adjustment section 28. The axial portion 30b is in a cylindrical shape protruding rearward from the central portion of the base portion 30a. The restricted protruding portions 30c protrude outward from the positions of the rear end portion of the axial portion 30b that are 180 degrees apart in the circumferential direction.

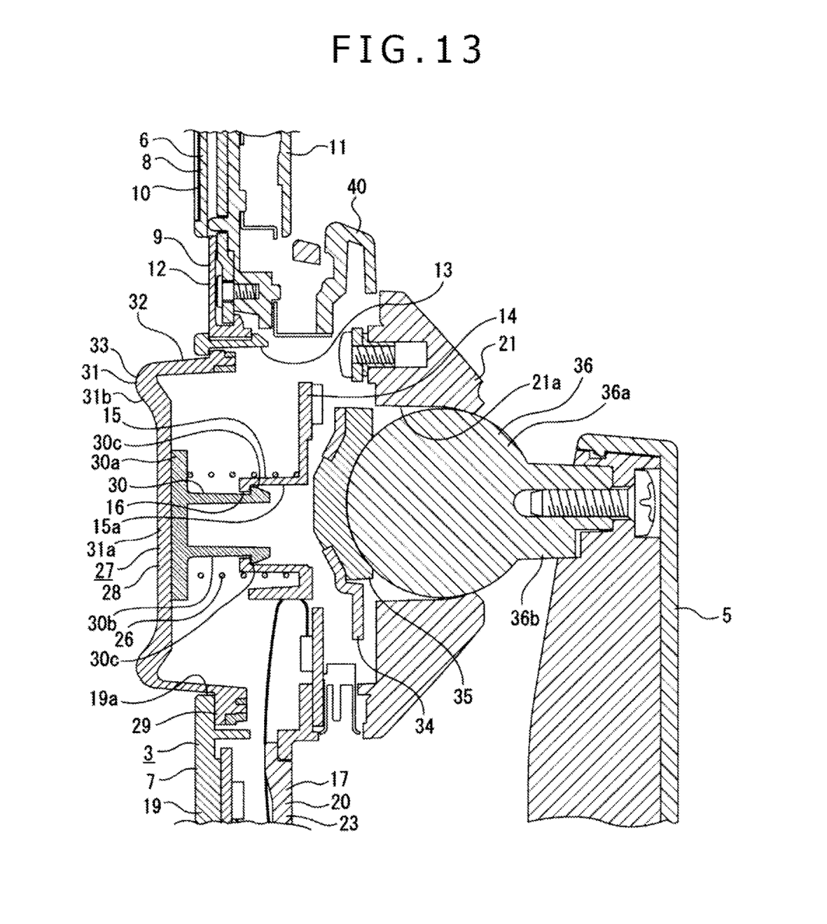

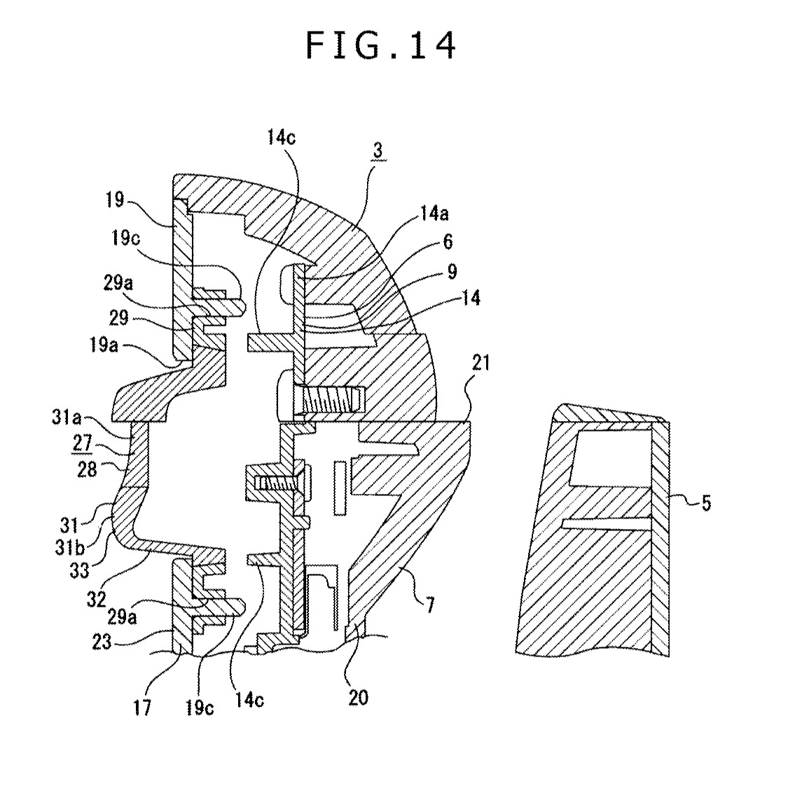

The adjuster 27 is supported by the lower enclosure in a manner free to move longitudinally when the axial portion 30b of the supported section 30 is inserted from the front into the insertion hole 15a of the supporting protruding portion 15 (refer to FIGS. 13 and 14).

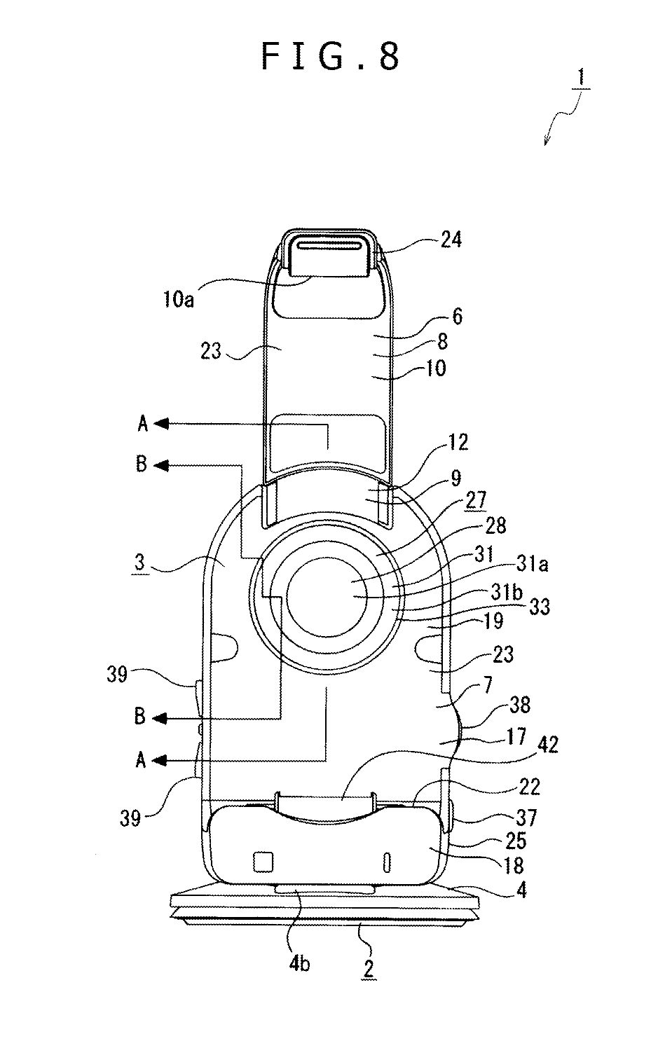

It should be noted that FIGS. 13 and 14 are respectively enlarged cross-sectional diagrams taken along lines A-A and Y-Y in FIG. 8.

At this time, the axial portion 30b of the supported section 30 is inserted into the insertion hole 15a as each of the restricted protruding portions 30c is inserted into one of the insertion cutouts 16a. When the adjuster 27 is rotated by a predetermined angle with the axial portion 30b inserted in the insertion hole 15a, the restricted protruding portions 30c can engage with the anti-slipout portion 16.

With the adjuster 27 supported by the lower enclosure 7, the biasing spring 26 is pressed against the rear surface of the base portion 30a of the supported section 30, thus causing the adjuster 27 to be biased forward by the biasing spring 26. Therefore, when no force is applied in the direction in which the adjuster 27 is moved rearward, the restricted protruding portions 30c engage with the anti-slipout portion 16, causing the adjuster 27 to be located at the forward movement end.

The adjuster 27 is supported when the adjustment section 28 is inserted into the insertion/arrangement hole 19a of the front panel 19. With the adjustment section 28 inserted in the insertion/arrangement hole 19a, each of the guide sections 19c of the front panel 19 is inserted into one of the guided holes 29a formed in the flange section 29 of the adjuster 27, causing the adjuster 27 to be guided by the guide sections 19c and allowing the adjuster 27 to move longitudinally.

A hold-down spring 34 and receiving member 35 are arranged in this order from the front in the protruding arrangement section 21 of the frame section 17 of the lower enclosure 7 (refer to FIG. 4). The hold-down spring 34 is arranged apart from the substrate portion 14 in the inner structure section 9 of the upper enclosure 6 on the rear side of the substrate portion 14.

A support 36 is arranged on the rear side of the receiving member 35. The support 36 includes a spherical section 36a and connecting shaft section 36b. The spherical section 36a is formed in a spherical form. The connecting shaft section 36b protrudes rearward from the spherical section 36a. The portions of the support 36 other than the rear end portion of the spherical section 36a are arranged inside the protruding arrangement section 21. The connecting shaft section 36b protrudes rearward from the axial insertion hole 21a formed in the rear cabinet 20 of the lower enclosure 7.

The receiving member 35 is pressed against the spherical section 36a of the support 36 from the front by the hold-down spring 34, thus generating a given frictional force between the spherical section 36a and receiving member 35. The receiving member 35 is supported by the spherical section 36a of the support 36 in a manner free to rotate in an arbitrary direction.

The connecting shaft section 36b of the support 36 is connected to the upper end portion of the supporting leg 5 of the stand 2 (refer to FIGS. 3 and 7). With the connecting shaft section 36b of the support 36 connected to the supporting leg 5, the holder 3 can pivot in an arbitrary direction when the receiving member 35 is slid by the spherical section 36a of the support 36. At the same time, a frictional force is generated between the spherical section 36a and receiving member 35 by the biasing force of the hold-down spring 34, thus allowing the holder 3 to be held at the arbitrary position to which it has been pivoted.

Operation sections 37, 38, 39 and 40 are arranged on the frame section 17 of the lower enclosure 7 (refer to FIGS. 7, 8 and 15). The operation sections 37, 38, 39 and 40 respectively serve, for example, as a power button, a music data volume adjustment knob, a fast-forward/reverse button for music data recorded on the electronic device 100 and a button adapted to permit or restrict the movement of the upper enclosure 6 relative to the lower enclosure 7.

A rotational movement member 41 is supported in a manner free to pivot at the lower end portion inside the frame section 17 of the lower enclosure 7. With part of the rotational movement member 41 arranged in the insertion/arrangement hole 19b of the front panel 19, the rotational movement member 41 is free to pivot about horizontally extending rotational movement axis not shown as a fulcrum.

A male connector 42 is attached to the rotational movement member 41. The male connector 42 protrudes upward from the rotational movement member 41 and is located on the top side of the holding protruding section 25.

When supported by the frame section 17, the rotational movement member 41 is biased by a spring member not shown in the direction in which it is pivoted forward. When no external force is applied to the male connector 42, the male connector 42 is maintained at the initial position, i.e., the position at which the male connector 42 is tilted forward by θ degrees such as 6 degrees relative to a vertical direction H by the biasing force of the spring member (refer to FIG. 7).

The male connector 42 is pivoted with respect to the initial position and can be pivoted, for example, until it is tilted forward by 25 degrees relative to the vertical direction H and pivoted rearward until it reaches the vertical direction H, i.e., 0 degree. Therefore, if a force is no longer applied in the direction in which the male connector 42 is pivoted with respect to the initial position, the male connector 42 always returns to the initial position (6-degree state) by the biasing force of the spring member.

### [Connections of the Connection Device]

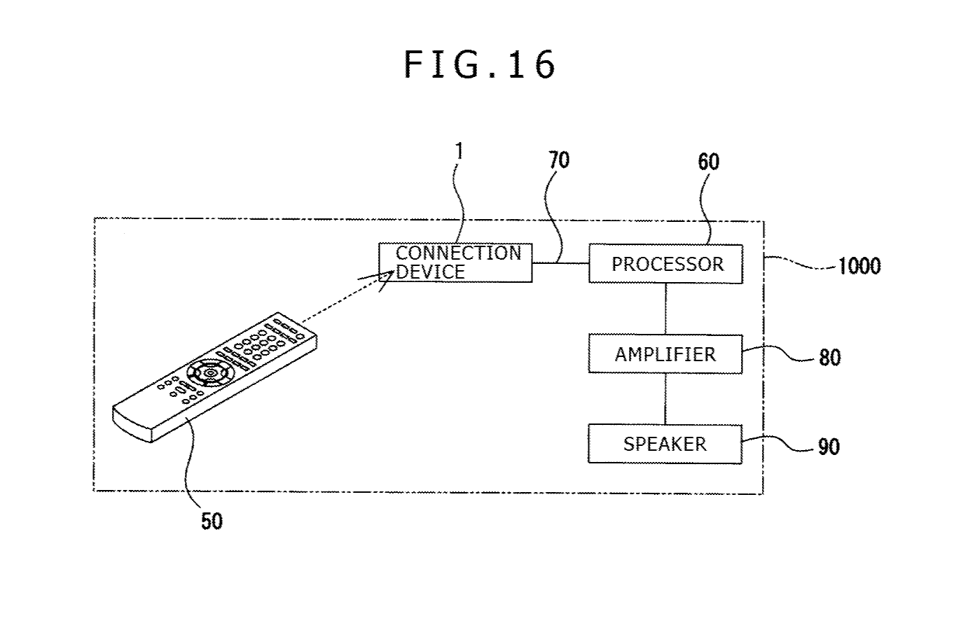

A description will be given below of the connections of the connection device 1 to other sections (refer to FIG. 16).

The connection device 1 configured as described above is used, for example, in a vehicle 1000. The connection device 1 is attached, for example, to the dashboard in the vehicle 1000 and operated not only manually but also by using a remote controller 50.

The connection device 1 is connected, for example, to a processor (digital signal processor unit) 60 adapted to output data and other information to a vehicle-mounted speaker unit. The connection between the connection device 1 and processor 60 is achieved by the connection of a cable 70 to a connection connector of the connection device 1 and the connection terminal of the processor 60.

The processor 60 is connected to a speaker 90 serving as a sound output device via an amplifier 80 serving as an amplifying circuit, thus performing predetermined processes on the amplifier 80 and speaker 90 and controlling these devices.

The sound data output from the connection device 1 is transmitted to the processor 60 and output from the processor 60 to the amplifier 80 where the data is amplified, after which the data is output from the speaker 90 as a high-quality sound.

[Attachment and Detachment of Electronic Device to and from the Connection Device]

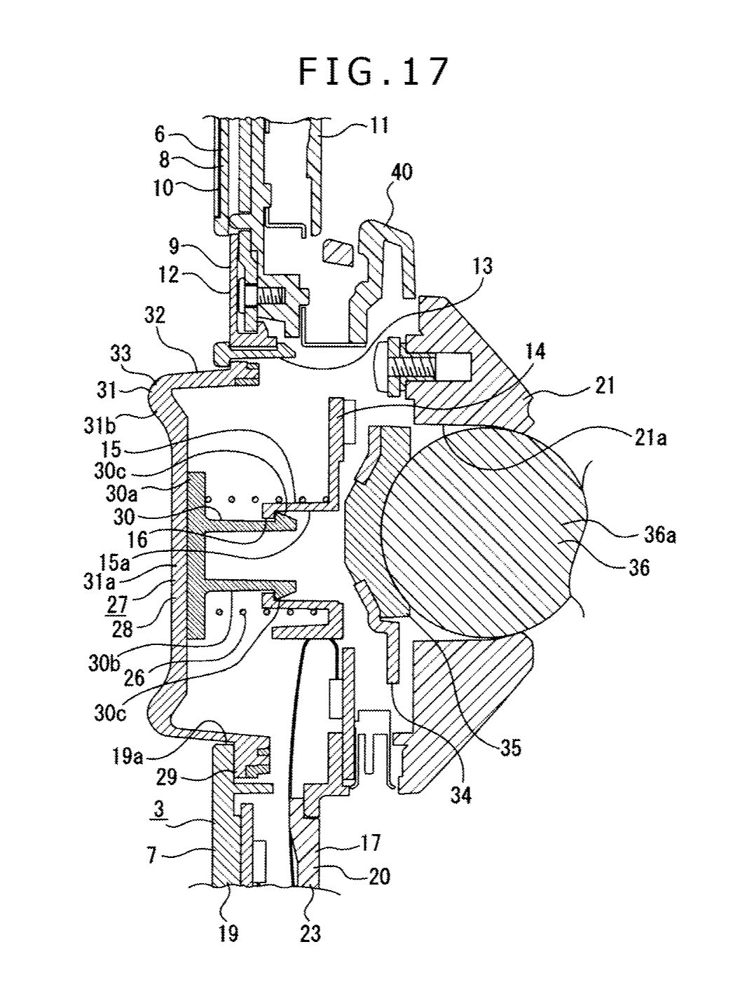

A description will be given below of the attachment and detachment of the electronic device 100 or 200 to and from the connection device 1 (refer to FIGS. 17 to 32).

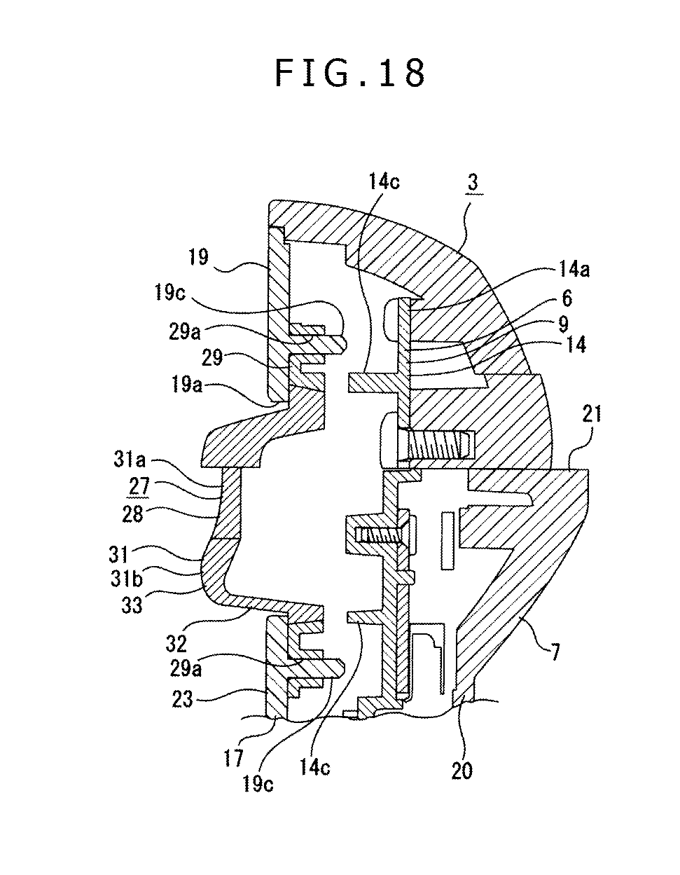

Before the connection of the electronic device 100 or 200, the adjuster 27 is located at the forward movement end by the biasing force of the biasing spring 26 (refer to FIGS. 17 and 18). At this time, the adjuster 27 is located in front of and apart from the movement restriction parts 14c that are provided on the substrate portion 14 of the upper enclosure 6 (refer to FIG. 18).

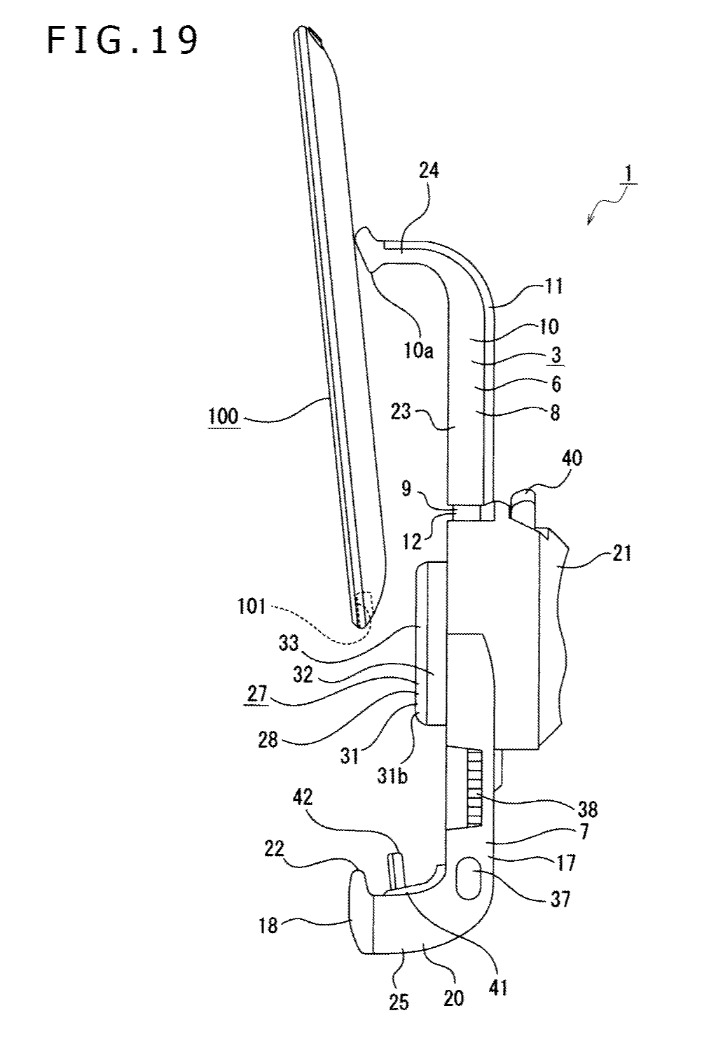

Before the connection of the electronic device 100 or 200, the male connector 42 is located at the initial position and tilted, for example, by 6 degrees forward relative to the direction in which the base section 23 of the holder 3 extends (vertical direction), i.e., tilted toward the restriction protruding section 22 (refer to FIG. 19). At this time, the upper enclosure 6 is located at the upper movement end as a result of the upward movement relative to the lower enclosure 7.

A description will be given first of the attachment and detachment of the electronic device 100 (refer to FIGS. 19 to 25).

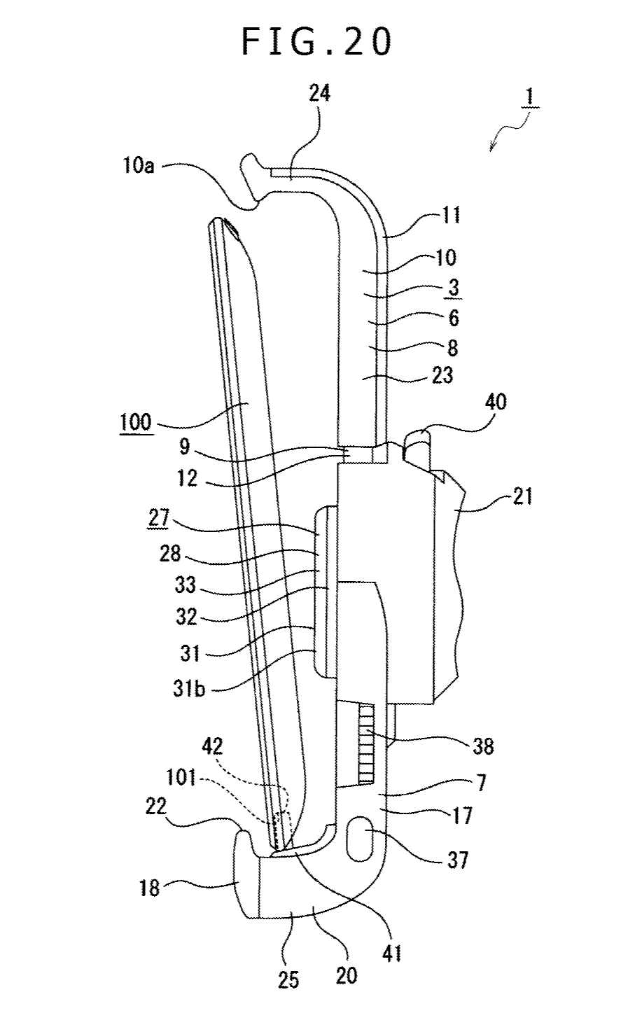

The electronic device 100 is moved from top to bottom along the base section 23 of the holder 3 while being tilted somewhat forward to avoid interference with the upper holding protruding section 24 (refer to FIG. 19), thus allowing the female connector 101 to be connected to the male connector 42 (refer to FIG. 20).

At this time, the male connector 42 is tilted toward the restriction protruding section 22. This makes it easy to insert the male connector 42 into the female connector 101 of the electronic device 100, thus ensuring proper attachment or detachment of the female connector 101 to or from the male connector 42 and proper connection between the two connectors.

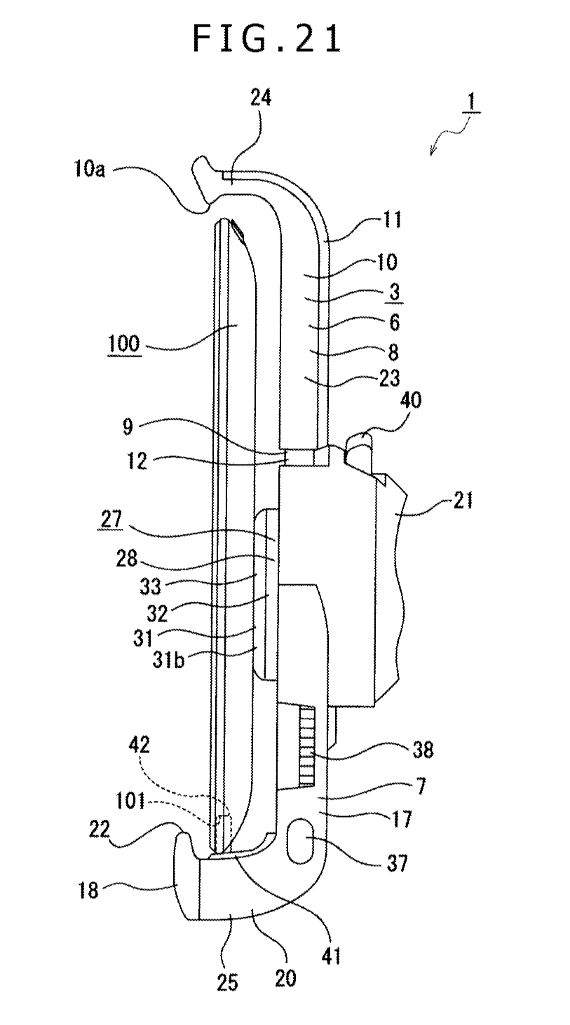

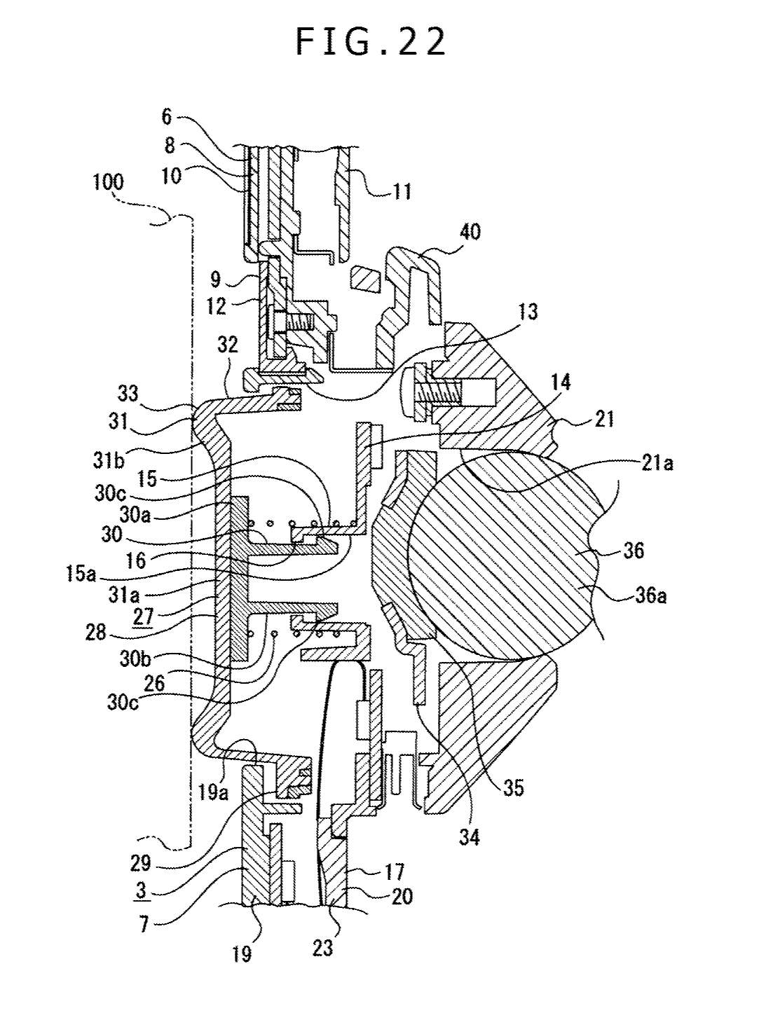

Next, the electronic device 100 is pressed rearward to ensure that the electronic device 100 is parallel to the base section 23 (refer to FIG. 21). At this time, the adjuster 27 is pressed by the electronic device 100, thus compressing the biasing spring 26 and moving the adjuster 27 rearward against the biasing force of the biasing spring 26 (refer to FIG. 22). As a result, the adjustment section 28 is pressed against the rear surface of the electronic device 100 by the biasing force of the biasing spring 26.

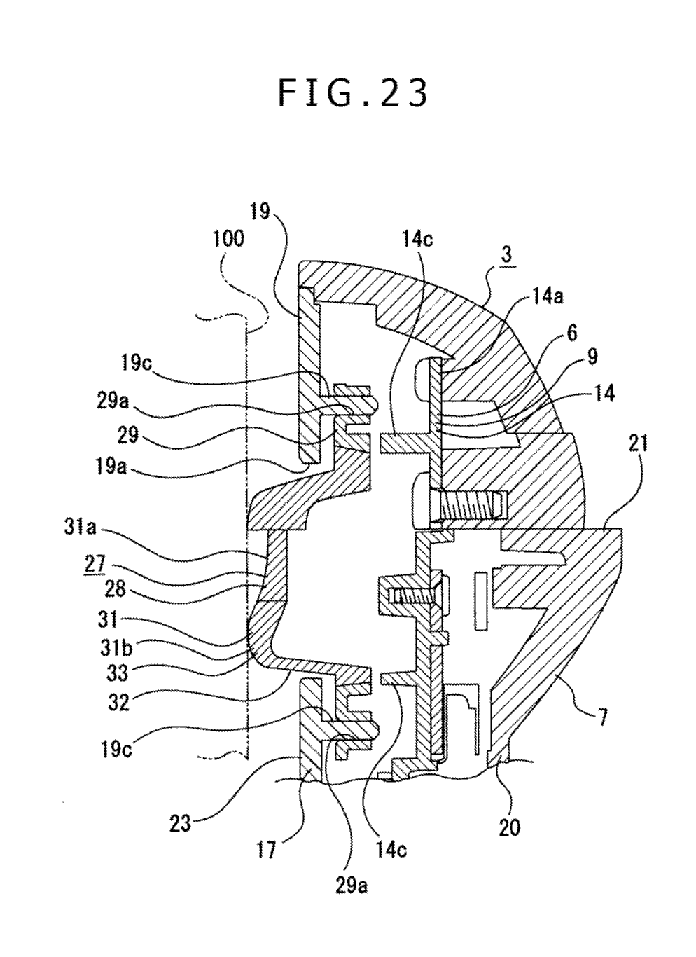

When moved rearward, the adjuster 27 is guided by the guide sections 19c provided on the front panel 19 (refer to FIG. 23).

Therefore, the adjuster 27 is not tilted in the longitudinal direction, thus ensuring smooth movement of the adjuster 27.

When pressed rearward, the electronic device 100 is pivoted about its lower end portion as a fulcrum. At this time, the male connector 42 is pivoted in a manner integral with the rotational movement member 41. As described above, because the male connector 42 is pivoted, no load is applied to the male connector 42 when the electronic device 100 is pressed rearward, thus preventing the deformation of the male connector 42 when the electronic device 100 is pressed rearward.

When the electronic device 100 is parallel to the base section 23, the male connector 42 is pivoted to the vertical direction H (0 degree angle).

When the electronic device 100 is parallel to the base section 23, the rear surface of the flange section 29 of the adjuster 27 is located in proximity to the front surfaces of the movement restriction parts 14c (refer to FIG. 23).

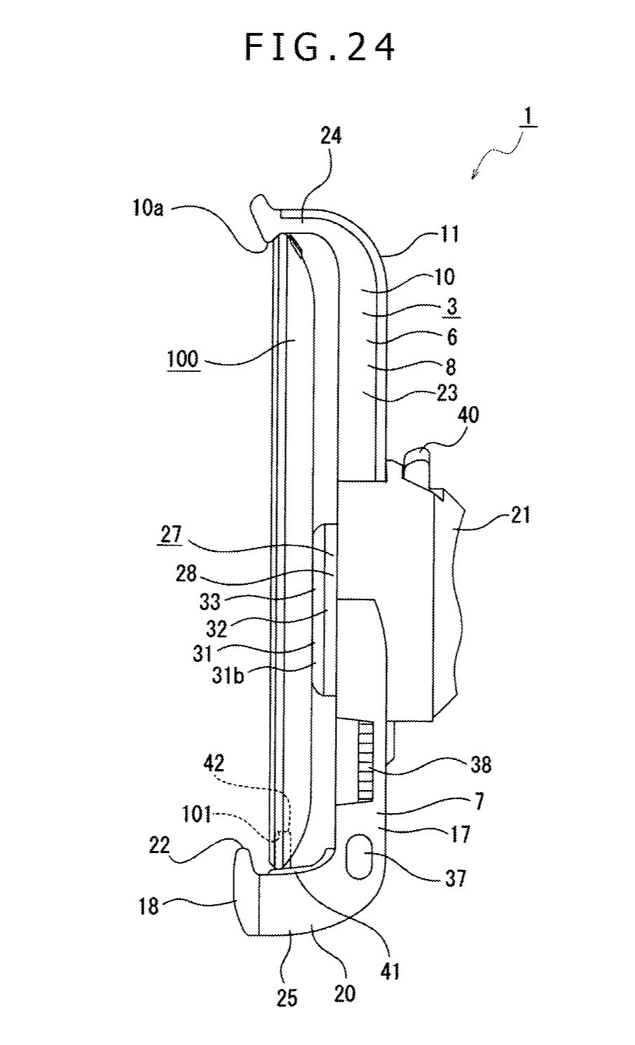

Next, the upper enclosure 6 is moved downward relative to the lower enclosure 7 (refer to FIG. 24). When the upper enclosure 6 is moved downward, the front edge of the upper end portion of the electronic device 100 engages with the position restriction protruding section 10a provided on the front end portion of the holding protruding section 24 of the upper enclosure 6. Therefore, the electronic device 100 is held by the holder 3. At this time, a biasing force is applied from the biasing spring 26 to the electronic device 100 via the adjuster 27. Therefore, the front edge of the upper end portion of the electronic device 100 is pressed against the position restriction protruding section 10a, thus maintaining the electronic device 100 engaged with the position restriction protruding section 10a.

When held by the holder 3, the electronic device 100 is parallel to the base section 23. With the electronic device 100 held by the holder 3, music data recorded on the electronic device 100 is output to the processor 60.

In order to remove the electronic device 100 from the connection device 1, the upper enclosure 6 is moved upward relative to the lower enclosure 7 first. When the upper enclosure 6 is moved upward, the position restriction protruding section 10a provided on the front end portion of the holding protruding section 24 of the upper enclosure 6 disengages from the front edge of the upper end portion of the electronic device 100, thus moving the adjuster 27 forward by the biasing force of the biasing spring 26 and pressing the electronic device 100 forward by the adjuster 27.

When pressed forward by the adjuster 27, the electronic device 100 is pivoted about its lower end portion as a fulcrum and is tilted forward. At this time, the male connector 42 is pivoted in a manner integral with the rotational movement member 41. As described above, because the male connector 42 is pivoted, no load is applied to the male connector 42 when the electronic device 100 is pressed forward, thus preventing the deformation of the male connector 42 when the electronic device 100 is pressed forward.

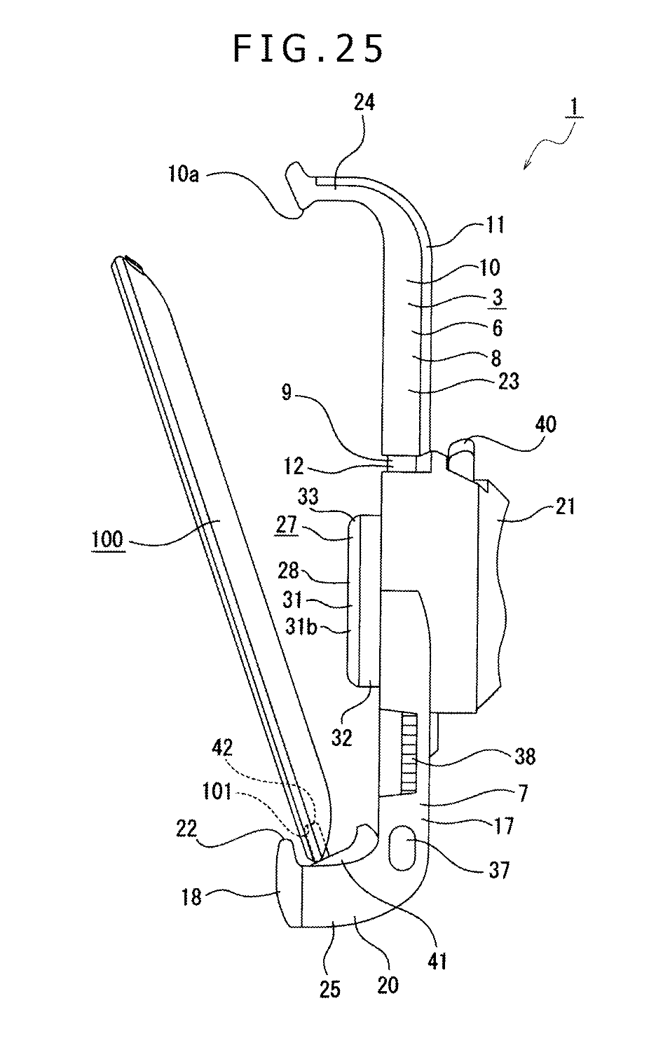

Next, the electronic device 100 is gripped and tilted further forward (refer to FIG. 25). When the electronic device 100 is tilted further forward, the male connector 42 is also pivoted in a manner integral with the rotational movement member 41.

The electronic device 100 can be tilted forward until the front surface of the lower end portion thereof comes into contact with the restriction protruding section 22. When the front surface of the lower end portion of the electronic device 100 comes into contact with the restriction protruding section 22, the forward tilting of the electronic device 100 is restricted.

Next, when the electronic device 100 is pulled out forward and diagonally upward, the female and male connectors 101 and 42 are disconnected from each other, thus allowing the electronic device 100 to be removed from the connection device 1.

When the electronic device 100 is removed from the connection device 1, the male connector 42 returns to the initial position by the biasing force of the spring member (refer to FIG. 19).

As described above, in the connection device 1, the male connector 42 can be pivoted in the opposite direction relative to the initial position, and a spring member is provided to bias the male connector 42 toward the initial position.

Before the connection of the electronic device 100 to the connection device 1, therefore, the male connector 42 is always maintained at the initial position, thus allowing the electronic device 100 or 200 to be readily attached to the connection device 1.

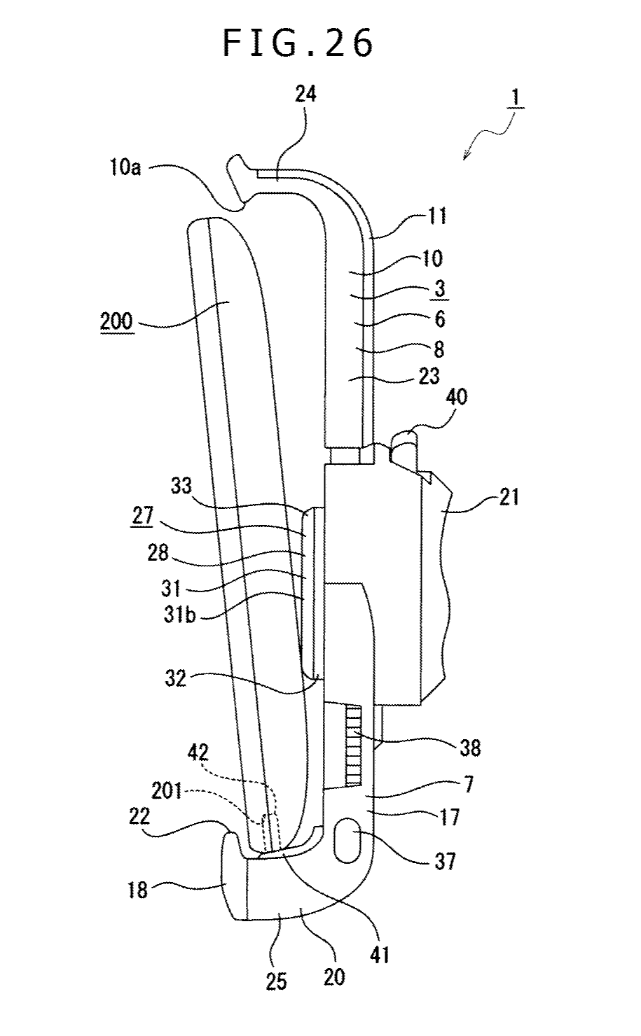

A description will be given next of attachment and detachment of the electronic device 200 (refer to FIGS. 26 to 30). The electronic device 200 is thicker than the electronic device 100.

The electronic device 200 is moved from top to bottom along the base section 23 of the holder 3 while being tilted somewhat forward to avoid interference with the upper holding protruding section 24 as is the electronic device 100, thus allowing the female connector 201 to be connected to the male connector 42.

At this time, the male connector 42 is tilted toward the restriction protruding section 22. This makes it easy to insert the male connector 42 into the female connector 201 of the electronic device 200, thus ensuring proper attachment or detachment of the female connector 201 to or from the male connector 42 and proper connection between the two connectors.

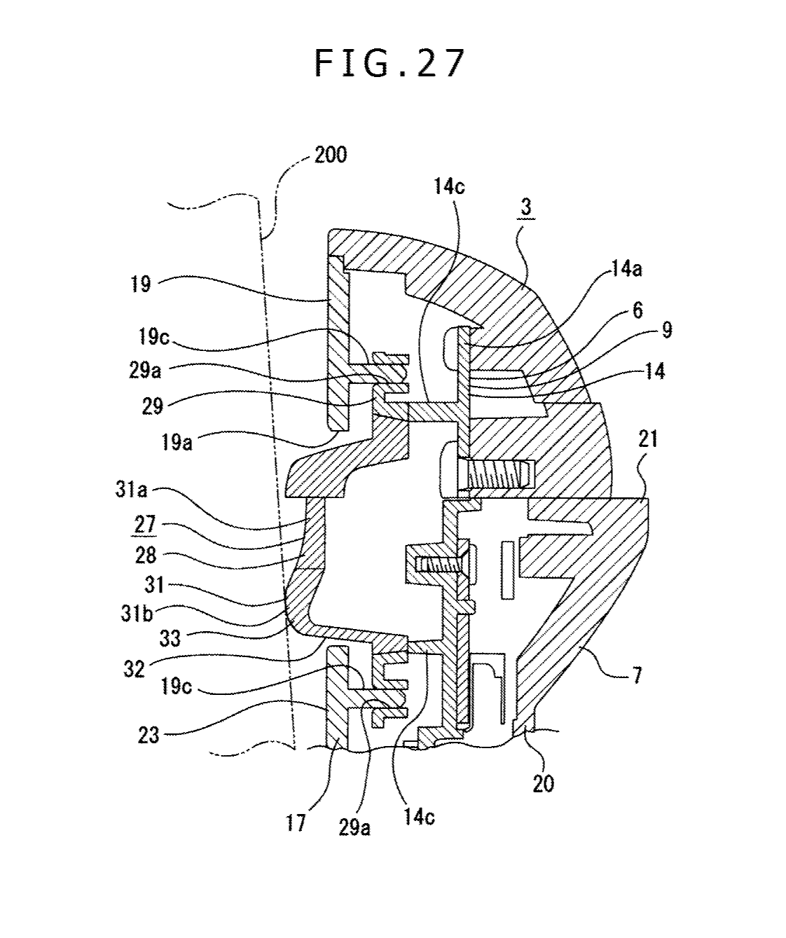

Next, the electronic device 200 is pressed rearward to ensure that the electronic device 200 is close to being parallel to the base section 23 (refer to FIG. 26). At this time, the adjuster 27 is pressed by the electronic device 200, thus compressing the biasing spring 26 and moving the adjuster 27 rearward against the biasing force of the biasing spring 26 (refer to FIG. 27). As a result, the adjustment section 28 is pressed against the rear surface of the electronic device 200 by the biasing force of the biasing spring 26.

When moved rearward, the adjuster 27 is guided by the guide sections 19c provided on the front panel 19.

Therefore, the adjuster 27 is not tilted in the longitudinal direction, thus ensuring smooth movement of the adjuster 27.

When pressed rearward, the electronic device 200 is pivoted about its lower end portion as a fulcrum. At this time, the male connector 42 is pivoted in a manner integral with the rotational movement member 41. As described above, because the male connector 42 is pivoted, no load is applied to the male connector 42 when the electronic device 200 is pressed rearward, thus preventing the deformation of the male connector 42 when the electronic device 200 is pressed rearward.

As the electronic device 200 becomes closer to being parallel to the base section 23, the rear surface of the flange section 29 of the adjuster 27 comes into contact with the front surfaces of the movement restriction parts 14c, thus restricting the rearward movement of the adjuster 27 (refer to FIG. 27).

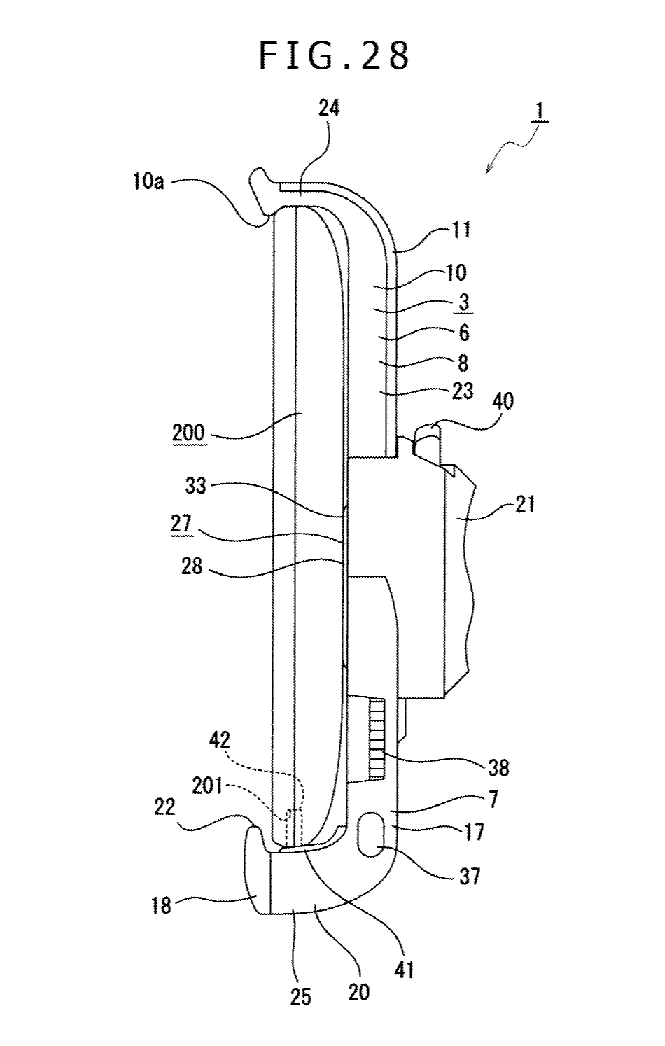

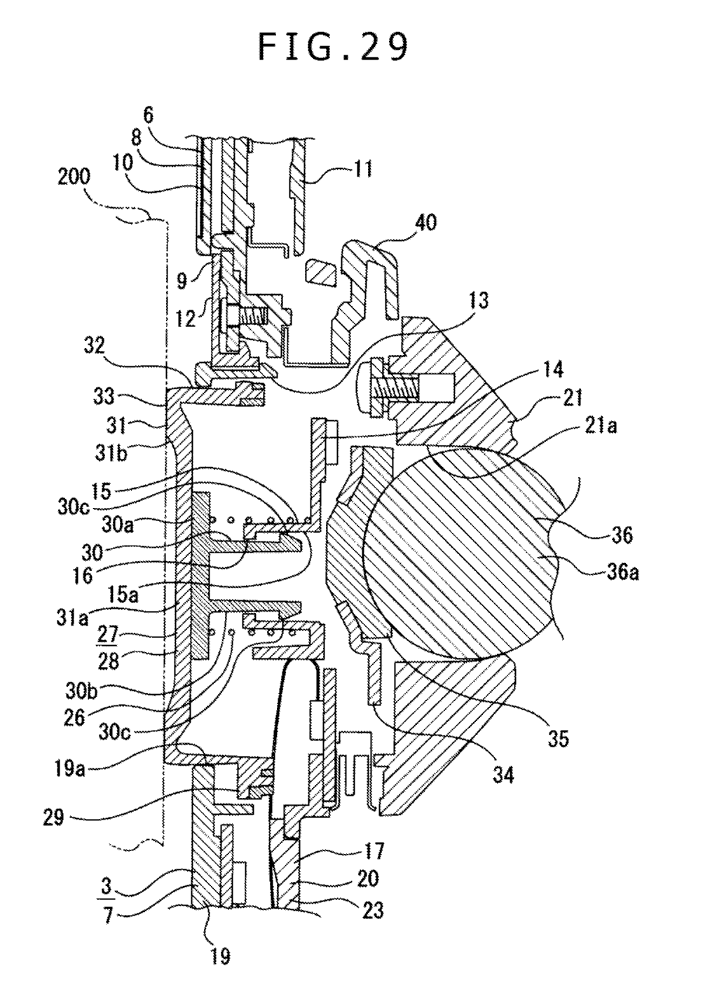

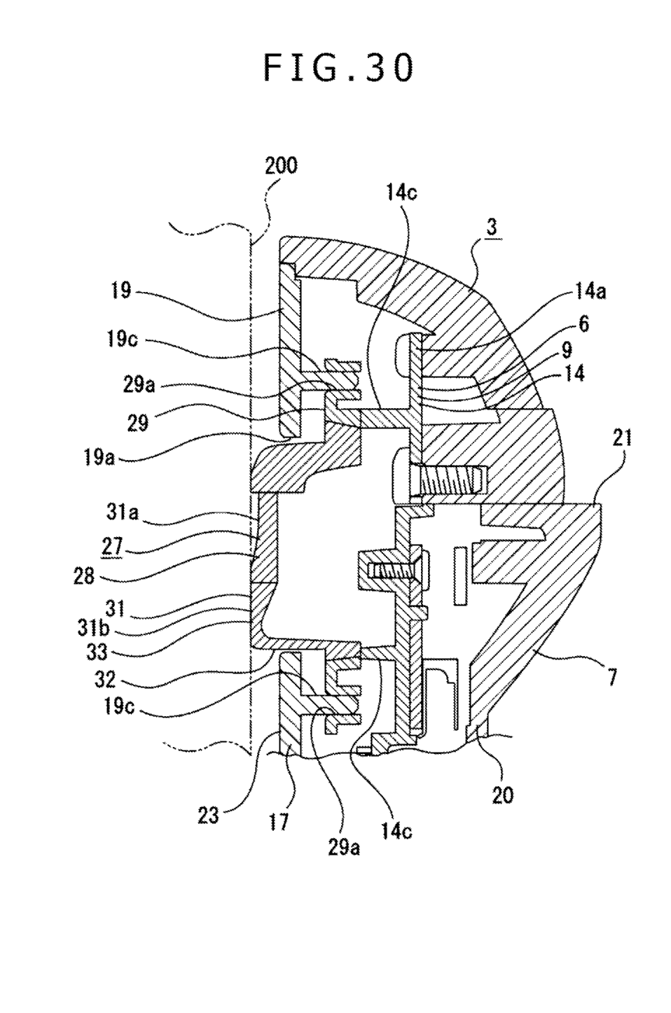

The electronic device 200 continues to be pressed rearward, thus rendering the electronic device 200 parallel to the base section 23 (refer to FIG. 28). At this time, the rearward movement of the adjuster 27 is restricted by the movement restriction parts 14c. Therefore, the elastic deformation section 33 of the adjuster 27 is pressed rearward by the electronic device 200, thus elastically deforming the elastic deformation section 33 relative to the other sections (refer to FIGS. 29 and 30). When the elastic deformation section 33 is elastically deformed, the contact portion 31 is moved rearward by the electronic device 200, further compressing the biasing spring 26.

As described above, the elastic deformation section 33 is formed with a rubber material such as elastomer. This makes it possible to positively elastically deform the elastic deformation section 33 when the adjuster 27 is pressed rearward by the electronic device 200.

Further, because the flange section 29 of the adjuster 27 is formed with a resin or metallic material, the adjuster 27 offers higher rigidity, thus preventing the adjuster 27 from being plastically deformed when pressed by the electronic device 100 or 200 and ensuring excellent functionality of the adjuster 27.

Still further, the elastic deformation section 33 is elastically deformed with the movement of the adjuster 27 restricted by the movement restriction parts 14c, thus allowing the adjuster 27 to move only a short distance and ensuring downsizing of the adjuster 27.

In addition, the outer peripheral portion 32 of the adjuster 27 is sloped gently in such a manner that the more rearward the outer peripheral portion 32 is, the somewhat more outward it is displaced. When elastically deformed, the elastic deformation section 33 does not squeeze out of the insertion/arrangement hole 19a of the front panel 19 (refer to FIGS. 29 and 30). Therefore, it is unlikely that part of the elastic deformation section 33 may be sandwiched between the rear surface of the electronic device 200 and the front surface of the front panel 19, thus ensuring proper holding of the electronic device 200 by the holder 3 and preventing scratches and damage to the adjuster 27.

When the electronic device 200 is parallel to the base section 23, the male connector 42 is pivoted to the vertical direction H (0 degree angle).

Next, the upper enclosure 6 is moved downward relative to the lower enclosure 7. When the upper enclosure 6 is moved downward, the front edge of the upper end portion of the electronic device 200 engages with the position restriction protruding section 10a provided on the front end portion of the holding protruding section 24 of the upper enclosure 6, thus allowing the electronic device 200 to be held by the holder 3. At this time, the biasing force of the biasing spring 26 and the elastic force of the elastic deformation section 33 are applied to the electronic device 200 via the adjuster 27. Therefore, the front edge of the upper end portion of the electronic device 200 is pressed against the position restriction protruding section 10a, thus maintaining the electronic device 200 engaged with the position restriction protruding section 10a.

When held by the holder 3, the electronic device 200 is parallel to the base section 23. With the electronic device 200 held by the holder 3, music data recorded on the electronic device 200 is output to the processor 60.

In order to remove the electronic device 200 from the connection device 1, the upper enclosure 6 is moved upward relative to the lower enclosure 7 first. When the upper enclosure 6 is moved upward, the position restriction protruding section 10a provided on the front end portion of the holding protruding section 24 of the upper enclosure 6 disengages from the front edge of the upper end portion of the electronic device 200, thus moving the adjuster 27 forward by the elastic force of the elastic deformation section 33 and the biasing force of the biasing spring 26 and pressing the electronic device 200 forward by the adjuster 27.

The adjuster 27 is restored to its original state when the elastic deformation section 33 springs back.

When pressed forward by the adjuster 27, the electronic device 200 is pivoted about its lower end portion as a fulcrum and is tilted forward. At this time, the male connector 42 is pivoted in a manner integral with the rotational movement member 41. As described above, because the male connector 42 is pivoted, no load is applied to the male connector 42 when the electronic device 200 is pressed forward, thus preventing the deformation of the male connector 42 when the electronic device 200 is pressed forward.

Next, the electronic device 200 is gripped and tilted further forward. When the electronic device 200 is tilted further forward, the male connector 42 is also pivoted in a manner integral with the rotational movement member 41.

The electronic device 200 can be tilted forward until the front surface of the lower end portion thereof comes into contact with the restriction protruding section 22. When the front surface of the lower end portion of the electronic device 200 comes into contact with the restriction protruding section 22, the forward tilting of the electronic device 200 is restricted.

Next, when the electronic device 200 is pulled out forward and diagonally upward, the female and male connectors 201 and 42 are disconnected from each other, thus allowing the electronic device 200 to be removed from the connection device 1.

When the electronic device 200 is removed from the connection device 1, the male connector 42 returns to the initial position by the biasing force of the spring member (refer to FIG. 19).

As described above, in the connection device 1, the male connector 42 can be pivoted in the opposite direction relative to the initial position, and a spring member is provided to bias the male connector 42 toward the initial position.

Before the connection of the electronic device 200 to the connection device 1, therefore, the male connector 42 is always maintained at the initial position, thus allowing the electronic device 100 or 200 to be readily attached to the connection device 1.

It should be noted that a description has been given of the attachment and detachment of the electronic devices 100 and 200 to and from the connection device 1 when the electronic devices 100 and 200 do not respectively have the protective covers 300 and 400. However, it is also possible to attach and detach the electronic devices 100 and 200 to and from the connection device 1 when the electronic devices 100 and 200 respectively have the protective covers 300 and 400.

When the electronic device 100 with the protective cover 300 is attached to the connection device 1, the adjustment section 28 is pressed against the protective cover 300 of the electronic device 100 by the biasing force of the biasing spring 26. At this time, the rear surface of the flange section 29 of the adjuster 27 is located in proximity to or in contact with the front surface of the movement restriction parts 14c.

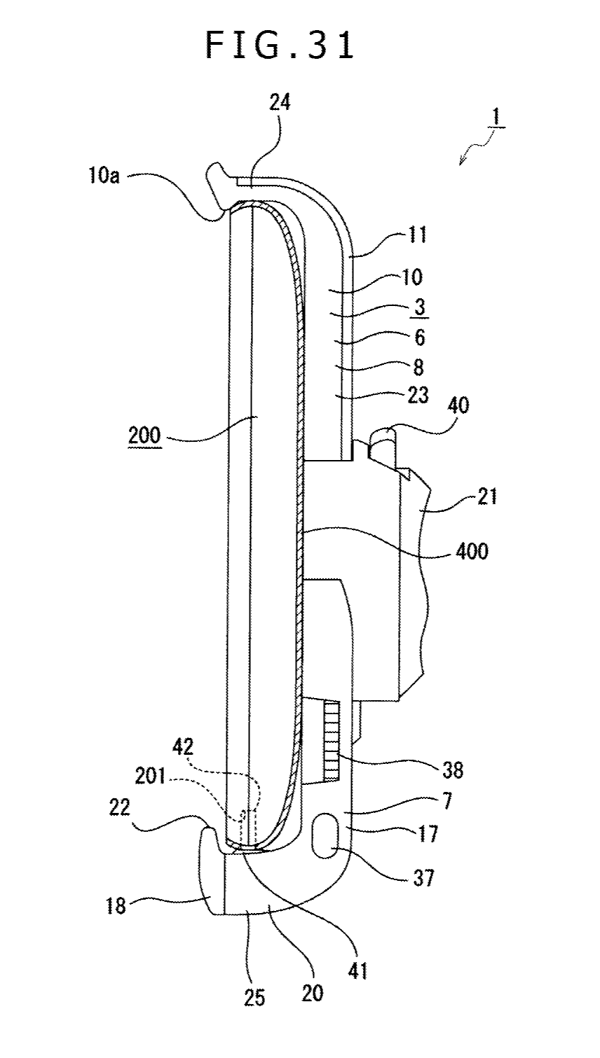

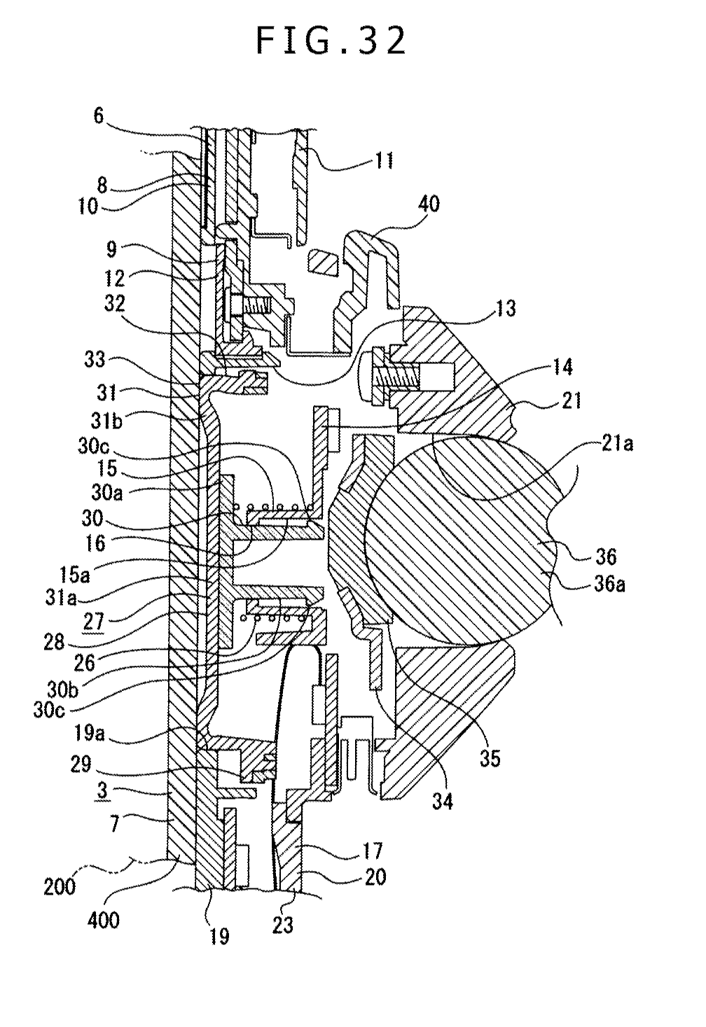

On the other hand, when the electronic device 200 with the protective cover 400 is attached to the connection device 1, the adjustment section 28 is pressed against the protective cover 400 of the electronic device 200 by the biasing force of the biasing spring 26 and the elastic force of the elastic deformation section 33 (refer to FIG. 31). At this time, the elastic deformation section 33 of the adjuster 27 is elastically deformed to a greater degree than if the electronic device 200 without the protective cover 400 is attached to the connection device 1 (refer to FIG. 32).

### CONCLUSION

As described above, in the connection device 1, part of the adjuster 27 is provided as the elastic deformation section 33 adapted to be elastically deformed when pressed by the electronic device 100 or 200. When the electronic device 100 or 200 is held by the holder 3, the adjuster 27 is moved according to the size of the electronic device 100 or 200, thus causing the biasing spring 26 or the biasing spring 26 and elastic deformation section 33 to be elastically deformed.

Therefore, when the larger electronic device 200 is held by the holder, the adjuster 27 is moved rearward to the predetermined position, and at the same time, the elastic deformation section 33 is elastically deformed at the predetermined rearward position where the adjuster 27 has been moved. As a result, the adjuster 27 does not move a given distance or more. This provides a sufficient space for the structure of other sections of the connection device 1, thus allowing the electronic devices 100 and 200 of different sizes to be held while at the same time ensuring downsizing.

Further, in the connection device 1, the attachment and detachment of the electronic devices 100 and 200 of different sizes and the electronic devices 100 and 200 respectively with the protective covers 300 and 400 to and from the connection device 1 can be always accomplished in the same manner, thus permitting easy attachment or detachment of the electronic device 100 or 200 to or from the holder 3.

Still further, in the connection device 1, the movement and deformation of the adjuster 27 is accomplished by the biasing force of the biasing spring 26 and the elastic force of the elastic deformation section 33 of the adjuster 27. This makes it possible to change the force (counterforce) applied by the adjuster 27 to the held electronic device 100 or 200 by properly setting the biasing force of the biasing spring 26, the distance over which the adjuster 27 is to be moved and the magnitude of deformation of the elastic deformation section 33.

For example, therefore, it is possible to ensure that a small counterforce is applied from the adjuster 27 to the thin and light electronic device 100, and that a large counterforce is applied from the adjuster 27 to the thick and heavy electronic device 200.

Still further, the adjuster 27 is moved in the direction along the thicknesses of the electronic devices 100 and 200. This makes it possible to hold the electronic devices 100 and 200 of different thicknesses while at the same time ensuring downsizing of the connection device 1 along the thicknesses of the electronic devices 100 and 200.

Still further, the adjuster 27 includes an area made of a rubber material such as elastomer and another made of a resin or metallic material, with the two areas formed integrally with each other. This makes it possible to readily form the adjuster 27 and reduce the number of components, thus contributing to reduced manufacturing cost of the connection device 1.

Still further, the guide sections 19c adapted to guide the adjuster 27 are formed integrally with the holder 3, thus contributing to a reduced number of components.

Still further, the movement restriction parts 14c adapted to restrict the movement of the adjuster 27 are formed integrally with the holder 3, thus contributing to a reduced number of components.

In addition, in the connection device 1, the base section 23 and the pair of holding protruding sections 24 and 25 are provided in the holder 3. The base section 23 supports the adjuster 27. The holding protruding sections 24 and 25 protrude approximately in the same direction respectively from the upper and lower end portions of the base section 23 and engage respectively with the upper and lower end portions of the electronic device 100 or 200 to sandwich the electronic device 100 or 200.

This makes it possible for the holder 3 to positively and readily hold the electronic device 100 or 200.

### [Present Technology]

The present technology may have the following configurations.

(1) A connection device including:

a holder adapted to hold an electronic device;

an adjuster that is supported by the holder in a manner free to move in a predetermined direction and that comes into contact with the electronic device held by the holder; and

a biasing spring adapted to bias the adjuster in the direction in which the adjuster is pressed against the electronic device held by the holder, in which

at least part of the adjuster is provided as an elastic deformation section that can be elastically deformed when pressed by the electronic device, and

when the electronic device is held by the holder, the adjuster is moved according to the size of the electronic device so as to cause the biasing spring or the biasing spring and elastic deformation section to elastically deform.

(2) The connection device of feature (1), in which

the predetermined direction is a direction along the thickness of the electronic device.

(3) The connection device of feature (1) or (2), in which

a flange section projecting outward from the elastic deformation section is provided on the adjuster, and

the flange section is formed with a resin or metallic material.

(4) The connection device of feature (3), in which

the elastic deformation section and other sections of the adjuster are integrally formed.

(5) The connection device of any one of features (1) to (4), in which

the elastic deformation section is formed with a rubber material.

(6) The connection device of any one of features (1) to (5), in which

a guide section is provided to guide the adjuster in the predetermined direction.

(7) The connection device of feature (6), in which

the guide section is provided integrally with the holder.

(8) The connection device of any one of features (1) to (7), in which

a movement restriction section is provided to restrict the movement of the adjuster in the predetermined direction by a given distance or more when the electronic device is held by the holder, and

the elastic deformation section can be elastically deformed when the movement of the adjuster is restricted by the movement restriction section.

(9) The connection device of feature (8), in which

the movement restriction section is provided integrally with the holder.

(10) The connection device of any one of features (1) to (9), in which

the adjuster has a contact section adapted to come into contact with the electronic device and an outer peripheral section adapted to protrude from an outer peripheral edge of the contact section,

an insertion/arrangement hole is formed to allow part of the adjuster to be inserted and arranged in the holder, and

the outer peripheral section is formed in such a manner as to be larger in outer diameter with increase in distance from the contact section.

(11) The connection device of any one of features (1) to (10), in which

a base section and a pair of holding protruding sections are provided in the holder, the base section supporting the adjuster, and each of the holding protruding sections protruding approximately in the same direction from one of two end portions of the base section and engaging with one of two end portions of the electronic device to sandwich the electronic device.

The specific shapes and structures of the different sections shown in the best mode for carrying out the embodiments of the present technology are merely examples of embodying the present technology, and should not be construed as limiting the technical scope of the present technology.

What is claimed is:

1. A connection device comprising:
a holder adapted to hold an electronic device;
an adjuster that is supported by the holder in a manner free to move in a predetermined direction and that comes into contact with the electronic device held by the holder; and
a biasing spring adapted to bias the adjuster in the direction in which the adjuster is pressed against the electronic device held by the holder, wherein
at least part of the adjuster is provided as an elastic deformation section that can be elastically deformed when pressed by the electronic device, and
when the electronic device is held by the holder, the adjuster is moved according to the size of the electronic device so as to cause the biasing spring or the biasing spring and elastic deformation section to elastically deform.

2. The connection device of claim 1, wherein
the predetermined direction is a direction along the thickness of the electronic device.

3. The connection device of claim 1, wherein
a flange section projecting outward from the elastic deformation section is provided on the adjuster, and
the flange section is formed with a resin or metallic material.

4. The connection device of claim 3, wherein
the elastic deformation section and other sections of the adjuster are integrally formed.

5. The connection device of claim 1, wherein
the elastic deformation section is formed with a rubber material.

6. The connection device of claim 1, wherein
a guide section is provided to guide the adjuster in the predetermined direction.

7. The connection device of claim 6, wherein
the guide section is provided integrally with the holder.

8. The connection device of claim 1, wherein
a movement restriction section is provided to restrict the movement of the adjuster in the predetermined direction by a given distance or more when the electronic device is held by the holder, and
the elastic deformation section can be elastically deformed when the movement of the adjuster is restricted by the movement restriction section.

9. The connection device of claim 8, wherein
the movement restriction section is provided integrally with the holder.

10. The connection device of claim 1, wherein
the adjuster has a contact section adapted to come into contact with the electronic device and an outer peripheral section adapted to protrude from an outer peripheral edge of the contact section, wherein
an insertion/arrangement hole is formed to allow part of the adjuster to be inserted and arranged in the holder, and
the outer peripheral section is formed in such a manner as to be larger in outer diameter with increase in distance from the contact section.

11. The connection device of claim 1, wherein
a base section and a pair of holding protruding sections are provided in the holder, the base section supporting the adjuster, and each of the holding protruding sections protruding approximately in the same direction from one of two end portions of the base section and engaging with one of two end portions of the electronic device to sandwich the electronic device.
